(19) United States
(12) Patent Application Publication
(10) Pub. No.: US 2024/0430804 A1
(43) Pub. Date: Dec. 26, 2024

(54) RESOURCE CONFIGURATION FOR RADIO FREQUENCY ENERGY-HARVESTING

(71) Applicant: QUALCOMM Incorporated, San Diego, CA (US)

(72) Inventors: Ahmed ELSHAFIE, San Diego, CA (US); Ahmed Attia ABOTABL, San Diego, CA (US); Alexandros MANOLAKOS, Athens (GR); Kianoush HOSSEINI, San Diego, CA (US)

(21) Appl. No.: 18/692,212

(22) PCT Filed: Oct. 25, 2022
(86) PCT No.: PCT/US2022/078638

§ 371 Date: Mar. 14, 2024

(30) Foreign Application Priority Data
Nov. 19, 2021 (GR) 20210100810

(51) Int. Cl. H04W 52/02; H02J 50/00; H02J 50/20; H04L 5/00

(52) U.S. Cl. CPC H04W 52/0235; H02J 50/001; H02J 50/20; H04L 5/0044; H04L 5/0094

(57) ABSTRACT

Disclosed are techniques for radio frequency energy harvesting (RF-EH). In an aspect, a communications device determines a set of resources associated with a data communication from a first device to a second device, and transmits, to at least a first user equipment (UE), an indication of the set of resources for radio frequency energy harvesting (RF-EH), wherein the first device and the second device are separate from the first UE. In a further aspect, the first UE receives an indication of a set of resources associated with a data communication from a first device to a second device, wherein the first device and the second device are separate from the first UE, and performs RF-EH on at least part of the set of resources.

### CROSS-REFERENCE TO RELATED APPLICATIONS

The present Application for Patent claims priority to Greek patent application Ser. No. 20210100810, entitled “RESOURCE CONFIGURATION FOR RADIO FREQUENCY ENERGY-HARVESTING,” filed Nov. 19, 2021, and is a national stage application, filed under 35 U.S.C. § 371, of International Patent Application No. PCT/US2022/078638, entitled “RESOURCE CONFIGURATION FOR RADIO FREQUENCY ENERGY-HARVESTING,” filed Oct. 25, 2022, both of which are assigned to the assignee hereof and expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Radio Frequency Energy Harvesting (RF-EH) may be used to prolong the battery lifetime of various UEs (e.g., wearables, etc.). RF-EH may also provide incentives for devices to cooperative and relay other signals. RF-EH is typically implemented at the receiving device on energy associated with SL, DL and/or UL communications in an opportunistic manner, without actual coordination with the transmission (or energy) source.

Aspects of the disclosure are thereby directed to conveying, to a UE, an indication of a set of resources associated with a data communication from a first device to a second device (e.g., the first device and the second device being separate from the UE). In this case, the UE need not be an intended target of the data communication to harvest energy therefrom. The UE also need not perform ‘blind’ energy harvesting on resources without advance knowledge of associated data communications thereon. Such aspects may provide various technical advantages, such as facilitating more efficient power generation at UEs based on RF-EH (e.g., more efficient in the sense that the RF-EH is performed by UE on resources that are already being transmitted upon for a data communication between other devices,

In an aspect, a method of operating a first user equipment (UE) includes receiving an indication of a set of resources associated with a data communication from a first device to a second device, wherein the first device and the second device are separate from the first UE; and performing radio frequency energy harvesting (RF-EH) on at least part of the set of resources.

In an aspect, a method of operating a communications device includes determining a set of resources associated with a data communication from a first device to a second device; and transmitting, to at least a first user equipment (UE), an indication of the set of resources for radio frequency energy harvesting (RF-EH), wherein the first device and the second device are separate from the first UE.

In an aspect, a first user equipment (UE) includes a memory; at least one transceiver; and at least one processor communicatively coupled to the memory and the at least one transceiver, the at least one processor configured to: receive, via the at least one transceiver, an indication of a set of resources associated with a data communication from a first device to a second device, wherein the first device and the second device are separate from the first UE; and perform radio frequency energy harvesting (RF-EH) on at least part of the set of resources.

In an aspect, a communications device includes a memory; at least one transceiver; and at least one processor communicatively coupled to the memory and the at least one transceiver, the at least one processor configured to: determine a set of resources associated with a data communication from a first device to a second device; and transmit, via the at least one transceiver, to at least a first user equipment (UE), an indication of the set of resources for radio frequency energy harvesting (RF-EH), wherein the first device and the second device are separate from the first UE.

In an aspect, a first user equipment (UE) includes means for receiving an indication of a set of resources associated with a data communication from a first device to a second device, wherein the first device and the second device are separate from the first UE; and means for performing radio frequency energy harvesting (RF-EH) on at least part of the set of resources.

In an aspect, a communications device includes means for determining a set of resources associated with a data communication from a first device to a second device; and means for transmitting, to at least a first user equipment (UE), an indication of the set of resources for radio frequency energy harvesting (RF-EH), wherein the first device and the second device are separate from the first UE.

In an aspect, a non-transitory computer-readable medium storing computer-executable instructions that, when executed by a first user equipment (UE), cause the first UE to: receive an indication of a set of resources associated with a data communication from a first device to a second device, wherein the first device and the second device are separate from the first UE; and perform radio frequency energy harvesting (RF-EH) on at least part of the set of resources.

In an aspect, a non-transitory computer-readable medium storing computer-executable instructions that, when executed by a communications device, cause the communications device to: determine a set of resources associated with a data communication from a first device to a second device; and transmit, to at least a first user equipment (UE), an indication of the set of resources for radio frequency energy harvesting (RF-EH), wherein the first device and the second device are separate from the first UE.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A to 3C are simplified block diagrams of several sample aspects of components that may be employed in a user equipment (UE), a base station, and a network entity, respectively, and configured to support communications as taught herein.

FIG. 4 illustrates an RF-EH-capable UE in accordance with an aspect of the disclosure

FIG. 5A depicts an RF-EH architecture (e.g., a separated receiver architecture) in accordance with an aspect of the disclosure.

FIG. 5B depicts an RF-EH architecture (e.g., a time-switching architecture) in accordance with another aspect of the disclosure.

FIG. 5C depicts an RF-EH architecture (e.g., a power-splitting architecture) in accordance with another aspect of the disclosure.

FIG. 6A illustrates a time-switching RF-EH architecture in accordance with an aspect of the disclosure.

FIG. 6B illustrates a power-splitting RF-EH architecture in accordance with an aspect of the disclosure.

FIG. 7A illustrates a TDD resource configuration in accordance with an aspect of the disclosure

FIG. 7B illustrates a TDD resource configuration in accordance with another aspect of the disclosure.

FIG. 8A illustrates an in-coverage (IC) scenario in accordance with an aspect of the disclosure

FIG. 8B illustrates an out-of-coverage (OOC) scenario in accordance with an aspect of the disclosure.

FIG. 8C illustrates a partial coverage (PC) scenario in accordance with an aspect of the disclosure.

FIG. 9A illustrates a sidelink communication scenario in accordance with an aspect of the disclosure.

FIG. 9B illustrates a sidelink communication scenario in accordance with another aspect of the disclosure.

FIG. 9C illustrates a sidelink communication scenario in accordance with another aspect of the disclosure.

FIG. 10A illustrates a wearable use-case in accordance with an aspect of the disclosure.

FIG. 10B illustrates a wearable use-case in accordance with another aspect of the disclosure.

FIG. 10C illustrates a wearable use-case in accordance with another aspect of the disclosure.

FIG. 11 is a diagram illustrating an example frame structure, according to aspects of the disclosure.

FIG. 12 is a diagram illustrating various downlink channels within an example downlink slot, according to aspects of the disclosure.

FIG. 13 is a diagram illustrating various uplink channels within an example uplink slot, according to aspects of the disclosure.

FIG. 14 illustrates an exemplary process of RF-EH, according to aspects of the disclosure.

FIG. 15 illustrates an exemplary process of wireless communication, according to aspects of the disclosure.

FIG. 16 is a conceptual data flow diagram illustrating the data flow between different means/components in exemplary apparatuses in accordance with an aspect of the disclosure.

FIG. 17 is a diagram illustrating an example of a hardware implementation for an apparatus employing a processing system.

FIG. 18 is a diagram illustrating an example of a hardware implementation for an apparatus employing a processing system.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

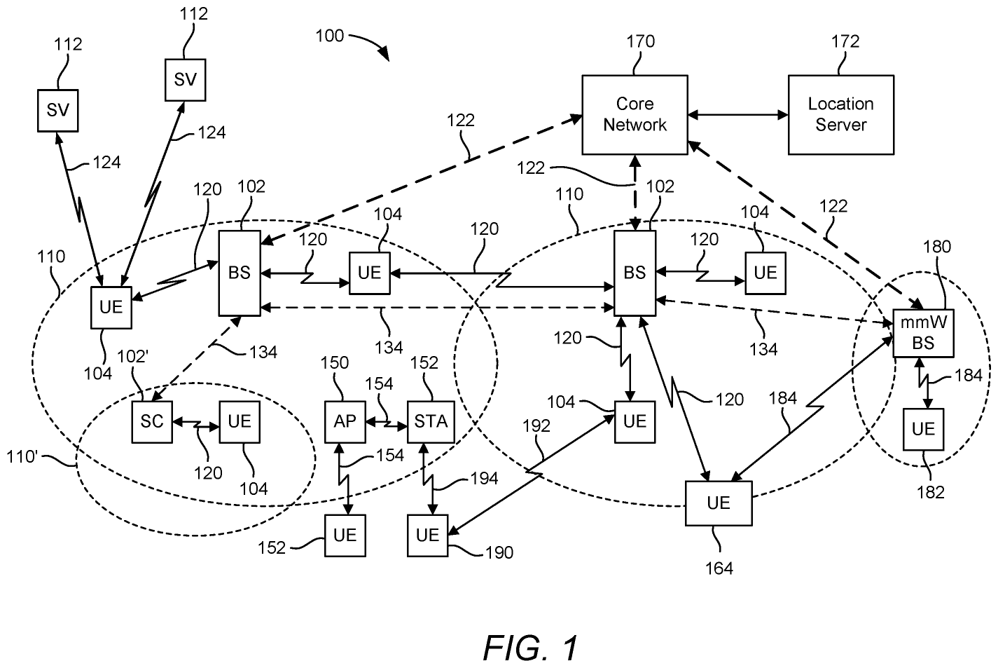

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IOT), enhanced mobile broadband (eMBB), or others) that may provide access for different types of UEs. Because a cell is supported by a specific base station, the term “cell” may refer to either or both of the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell (SC) base station 102′ may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a target reference RF signal on a target beam can be derived from information about a source reference RF signal on a source beam. If the source reference RF signal is QCL Type A, the receiver can use the source reference RF signal to estimate the Doppler shift, Doppler spread, average delay, and delay spread of a target reference RF signal transmitted on the same channel. If the source reference RF signal is QCL Type B, the receiver can use the source reference RF signal to estimate the Doppler shift and Doppler spread of a target reference RF signal transmitted on the same channel. If the source reference RF signal is QCL Type C, the receiver can use the source reference RF signal to estimate the Doppler shift and average delay of a target reference RF signal transmitted on the same channel. If the source reference RF signal is QCL Type D, the receiver can use the source reference RF signal to estimate the spatial receive parameter of a target reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a base station. The UE can then form a transmit beam for sending one or more uplink reference signals (e.g., uplink positioning reference signals (UL-PRS), sounding reference signal (SRS), demodulation reference signals (DMRS), PTRS, etc.) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHZ), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In the example of FIG. 1, one or more Earth orbiting satellite positioning system (SPS) space vehicles (SVs) 112 (e.g., satellites) may be used as an independent source of location information for any of the illustrated UEs (shown in FIG. 1 as a single UE 104 for simplicity). A UE 104 may include one or more dedicated SPS receivers specifically designed to receive SPS signals 124 for deriving geo location information from the SVs 112. An SPS typically includes a system of transmitters (e.g., SVs 112) positioned to enable receivers (e.g., UEs 104) to determine their location on or above the Earth based, at least in part, on signals (e.g., SPS signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104.

The use of SPS signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, an SPS may include any combination of one or more global and/or regional navigation satellite systems and/or augmentation systems, and SPS signals 124 may include SPS, SPS-like, and/or other signals associated with such one or more SPS.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

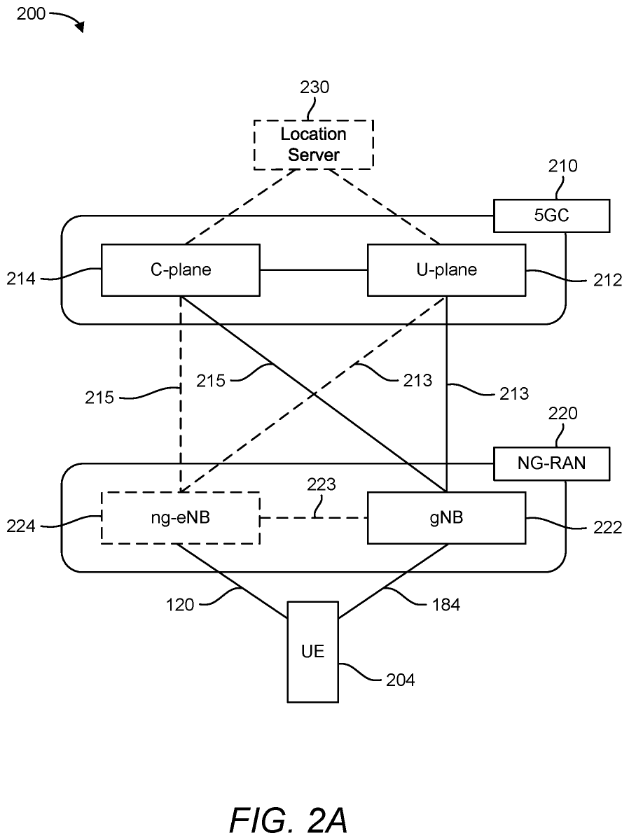

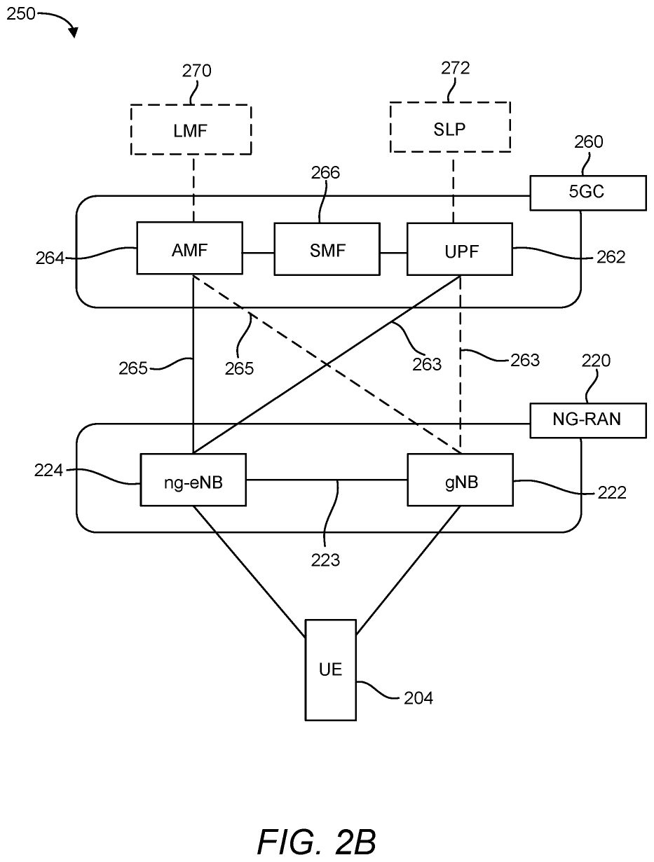

FIG. 2A illustrates an example wireless network structure 200. For example, a 5GC 210 (also referred to as a Next Generation Core (NGC)) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the control plane functions 214 and user plane functions 212. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). Another optional aspect may include location server 230, which may be in communication with the 5GC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). User plane interface 263 and control plane interface 265 connect the ng-eNB 224 to the 5GC 260 and specifically to UPF 262 and AMF 264, respectively. In an additional configuration, a gNB 222 may also be connected to the 5GC 260 via control plane interface 265 to AMF 264 and user plane interface 263 to UPF 262. Further, ng-eNB 224 may directly communicate with gNB 222 via the backhaul connection 223, with or without gNB direct connectivity to the 5GC 260. In some configurations, the NG-RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The base stations of the NG-RAN 220 communicate with the AMF 264 over the N2 interface and with the UPF 262 over the N3 interface.

The functions of the AMF 264 include registration management, connection management, reachability management, mobility management, lawful interception, transport for session management (SM) messages between the UE 204 and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and an LMF 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

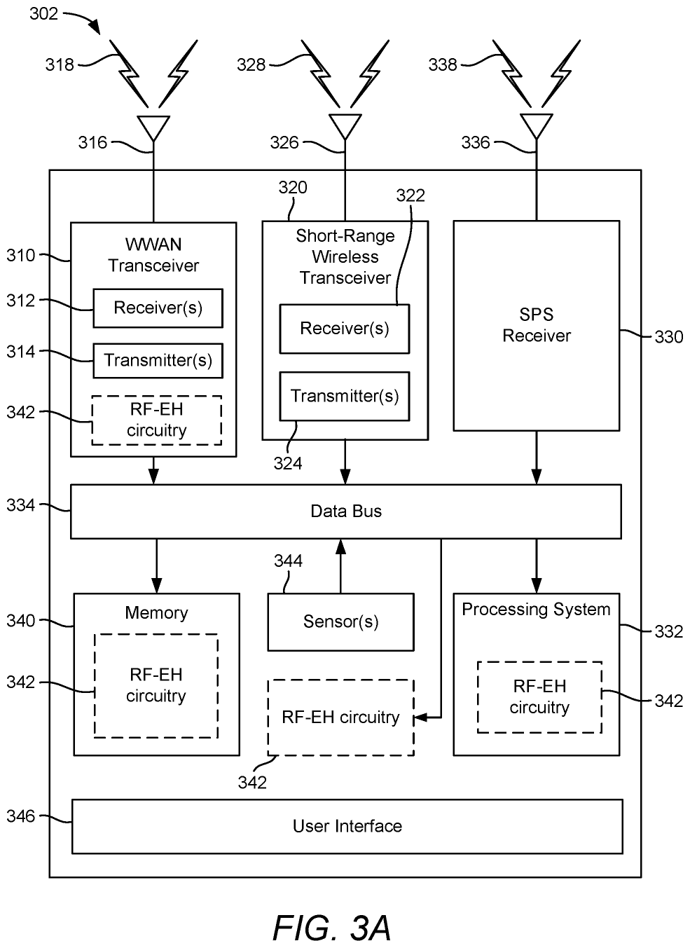

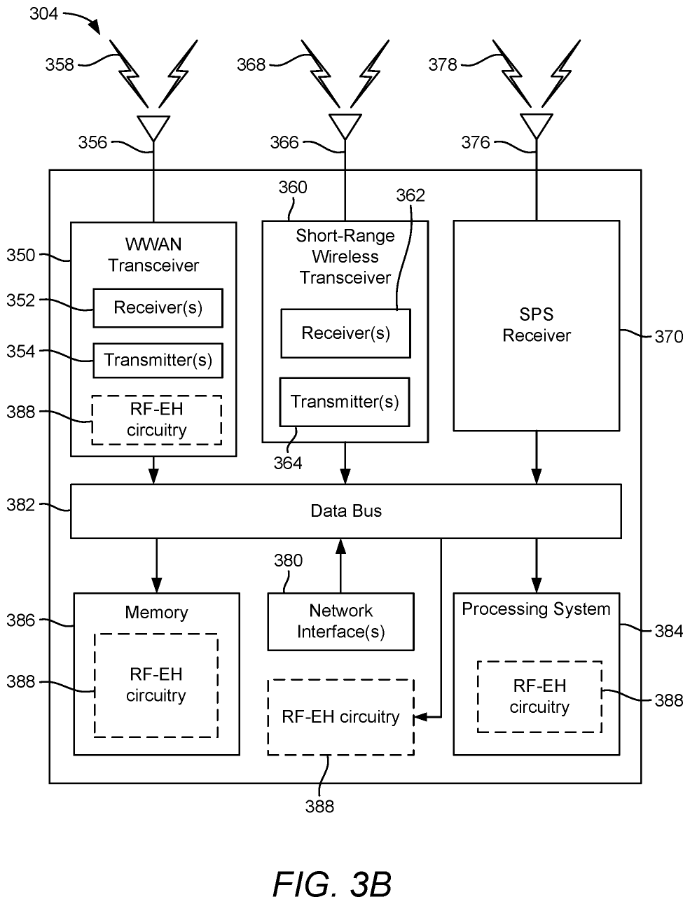

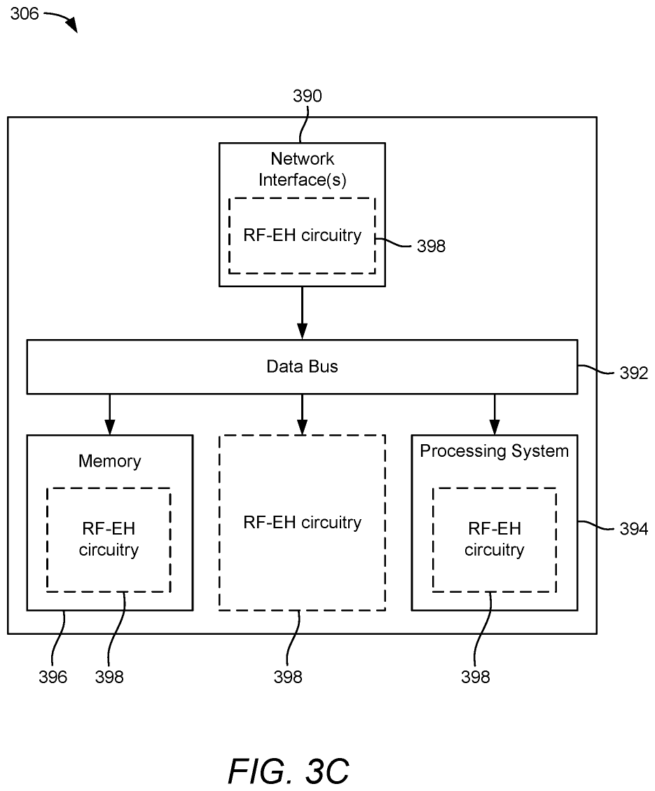

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include wireless wide area network (WWAN) transceiver 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

Transceiver circuitry including at least one transmitter and at least one receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 316, 326, 356, 366), such as an antenna array, that permits the respective apparatus to perform transmit “beamforming,” as described herein. Similarly, a receiver may include or be coupled to a plurality of antennas (e.g., antennas 316, 326, 356, 366), such as an antenna array, that permits the respective apparatus to perform receive beamforming, as described herein. In an aspect, the transmitter and receiver may share the same plurality of antennas (e.g., antennas 316, 326, 356, 366), such that the respective apparatus can only receive or transmit at a given time, not both at the same time. A wireless communication device (e.g., one or both of the transceivers 310 and 320 and/or 350 and 360) of the UE 302 and/or the base station 304 may also comprise a network listen module (NLM) or the like for performing various measurements.

The UE 302 and the base station 304 also include, at least in some cases, satellite positioning systems (SPS) receivers 330 and 370. The SPS receivers 330 and 370 may be connected to one or more antennas 336 and 376, respectively, and may provide means for receiving and/or measuring SPS signals 338 and 378, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 330 and 370 may comprise any suitable hardware and/or software for receiving and processing SPS signals 338 and 378, respectively. The SPS receivers 330 and 370 request information and operations as appropriate from the other systems, and performs calculations necessary to determine positions of the UE 302 and the base station 304 using measurements obtained by any suitable SPS algorithm.

The base station 304 and the network entity 306 each include at least one network interfaces 380 and 390, respectively, providing means for communicating (e.g., means for transmitting, means for receiving, etc.) with other network entities. For example, the network interfaces 380 and 390 (e.g., one or more network access ports) may be configured to communicate with one or more network entities via a wire-based or wireless backhaul connection. In some aspects, the network interfaces 380 and 390 may be implemented as transceivers configured to support wire-based or wireless signal communication. This communication may involve, for example, sending and receiving messages, parameters, and/or other types of information.

In an aspect, the WWAN transceiver 310 and/or the short-range wireless transceiver 320 may form a (wireless) communication interface of the UE 302. Similarly, the WWAN transceiver 350, the short-range wireless transceiver 360, and/or the network interface(s) 380 may form a (wireless) communication interface of the base station 304. Likewise, the network interface(s) 390 may form a (wireless) communication interface of the network entity 306.

The UE 302, the base station 304, and the network entity 306 also include other components that may be used in conjunction with the operations as disclosed herein. The UE 302 includes processor circuitry implementing a processing system 332 for providing functionality relating to, for example, wireless positioning, and for providing other processing functionality. The base station 304 includes a processing system 384 for providing functionality relating to, for example, wireless positioning as disclosed herein, and for providing other processing functionality. The network entity 306 includes a processing system 394 for providing functionality relating to, for example, wireless positioning as disclosed herein, and for providing other processing functionality. The processing systems 332, 384, and 394 may therefore provide means for processing, such as means for determining, means for calculating, means for receiving, means for transmitting, means for indicating, etc. In an aspect, the processing systems 332, 384, and 394 may include, for example, one or more processors, such as one or more general purpose processors, multi-core processors, ASICs, digital signal processors (DSPs), field programmable gate arrays (FPGA), other programmable logic devices or processing circuitry, or various combinations thereof.

The UE 302, the base station 304, and the network entity 306 include memory circuitry implementing memory components 340, 386, and 396 (e.g., each including a memory device), respectively, for maintaining information (e.g., information indicative of reserved resources, thresholds, parameters, and so on). The memory components 340, 386, and 396 may therefore provide means for storing, means for retrieving, means for maintaining, etc. In some cases, the UE 302, the base station 304, and the network entity 306 may include RF-EH circuitry 342, 388, and 398, respectively. The RF-EH circuitry 342, 388, and 398 may be hardware circuits that are part of or coupled to the processing systems 332, 384, and 394, respectively, that, when executed, cause the UE 302, the base station 304, and the network entity 306 to perform the functionality described herein. In other aspects, the RF-EH circuitry 342, 388, and 398 may be external to the processing systems 332, 384, and 394 (e.g., part of a modem processing system, integrated with another processing system, etc.). Alternatively, the RF-EH circuitry 342, 388, and 398 may be memory modules stored in the memory components 340, 386, and 396, respectively, that, when executed by the processing systems 332, 384, and 394 (or a modem processing system, another processing system, etc.), cause the UE 302, the base station 304, and the network entity 306 to perform the functionality described herein. FIG. 3A illustrates possible locations of the RF-EH circuitry 342, which may be part of the WWAN transceiver 310, the memory component 340, the processing system 332, or any combination thereof, or may be a standalone component. FIG. 3B illustrates possible locations of the RF-EH circuitry 388, which may be part of the WWAN transceiver 350, the memory component 386, the processing system 384, or any combination thereof, or may be a standalone component. FIG. 3C illustrates possible locations of the RF-EH circuitry 398, which may be part of the network interface(s) 390, the memory component 396, the processing system 394, or any combination thereof, or may be a standalone component.

The UE 302 may include one or more sensors 344 coupled to the processing system 332 to provide means for sensing or detecting movement and/or orientation information that is independent of motion data derived from signals received by the WWAN transceiver 310, the short-range wireless transceiver 320, and/or the SPS receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in 2D and/or 3D coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the processing system 384 in more detail, in the downlink, IP packets from the network entity 306 may be provided to the processing system 384. The processing system 384 may implement functionality for an RRC layer, a packet data convergence protocol (PDCP) layer, a radio link control (RLC) layer, and a medium access control (MAC) layer. The processing system 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the processing system 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the processing system 332, which implements Layer-3 (L3) and Layer-2 (L2) functionality.

In the uplink, the processing system 332 provides demultiplexing between transport and logical channels, packet reassembly, deciphering, header decompression, and control signal processing to recover IP packets from the core network. The processing system 332 is also responsible for error detection.

Similar to the functionality described in connection with the downlink transmission by the base station 304, the processing system 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the processing system 384.

In the uplink, the processing system 384 provides demultiplexing between transport and logical channels, packet reassembly, deciphering, header decompression, control signal processing to recover IP packets from the UE 302. IP packets from the processing system 384 may be provided to the core network. The processing system 384 is also responsible for error detection.

For convenience, the UE 302, the base station 304, and/or the network entity 306 are shown in FIGS. 3A to 3C as including various components that may be configured according to the various examples described herein. It will be appreciated, however, that the illustrated blocks may have different functionality in different designs.

The various components of the UE 302, the base station 304, and the network entity 306 may communicate with each other over data buses 334, 382, and 392, respectively. In an aspect, the data buses 334, 382, and 392 may form, or be part of, the communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A to 3C may be implemented in various ways. In some implementations, the components of FIGS. 3A to 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processing systems 332, 384, 394, the transceivers 310, 320, 350, and 360, the memory components 340, 386, and 396, the RF-EH circuitry 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

Various types of wireless energy-harvesting (EH) are implemented on UEs (e.g., electromagnetic charging such as Qi wireless charging, wind-based charging, solar-based charging, vibration-based charging, etc.). Another type of wireless charging is RF-EH. RF sources can provide a controllable and substantially constant energy transfer over distance for RF-EH-capable UEs. In a fixed RF-EH network, the harvested energy is predictable and relatively stable over time due to fixed distance.

Using random multipath fading channel model, the energy harvested at node j from a transmitting node i is given by

$${E}_{j} = η {P}_{i} {\vert {g}_{i - j} \vert}^{2} T \qquad Equation 1$$

where Pᵢ is the transmit power by node i, gᵢ₋ⱼ is the channel coefficient of the link between node i and node j, T is the time allocated for energy harvesting, and n is the RF-to-DC conversion efficiency.

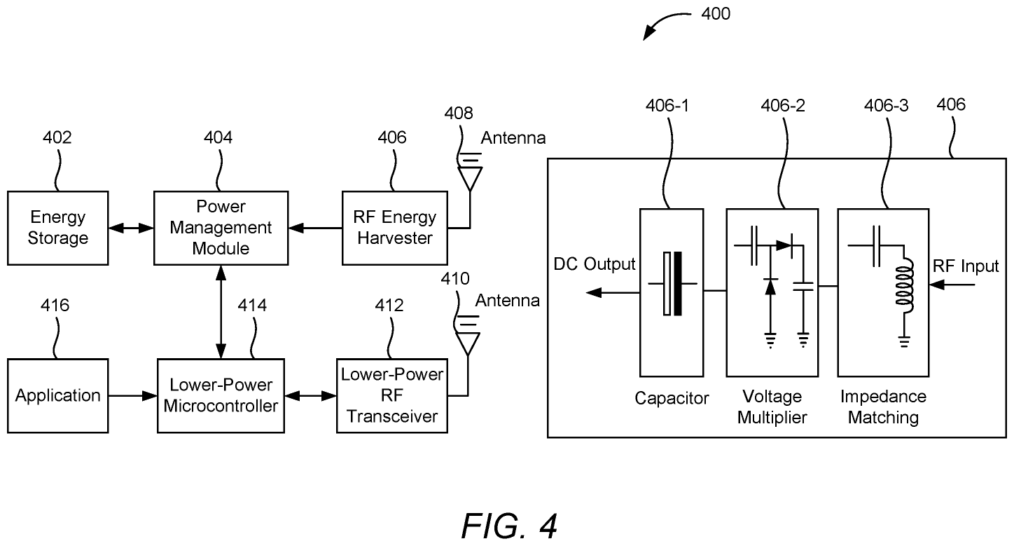

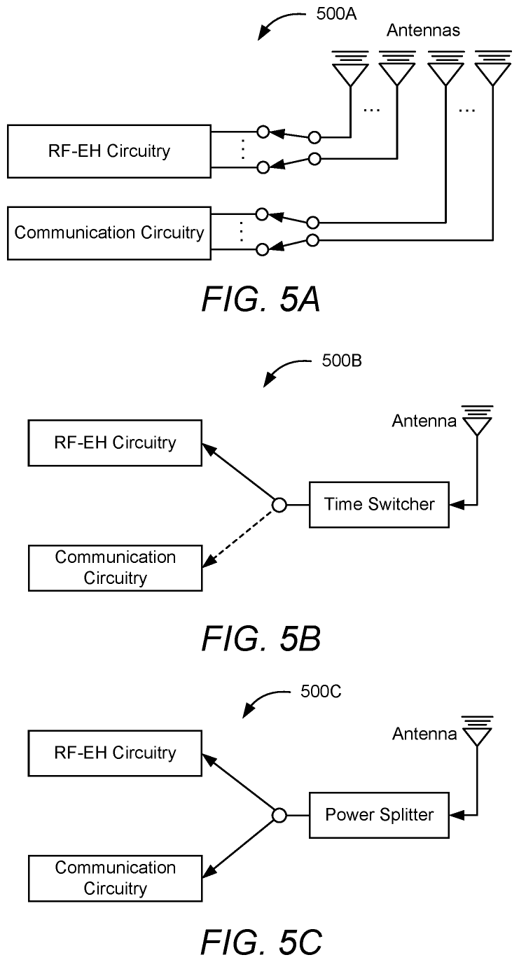

FIG. 4 illustrates an RF-EH-capable UE 400 in accordance with an aspect of the disclosure. In some designs, the RF-EH-capable UE 400 may correspond to an example implementation of UE 302. The RF-EH-capable UE 400 includes an energy storage unit 402 (e.g., a battery), a power management module 404 (e.g., which decides whether to store the electricity obtained from RF-EH or to use it for information transmission immediately), RF-EH circuitry 406 (e.g., to collect RF signals and convert them into electricity), antennas 408-410, a lower-power RF transceiver 412 (e.g., for information transmission or reception), a lower-power microcontroller 414 (e.g., to process data), and an application 410. The RF-EH circuitry 406 includes a capacitor 406-1, a voltage multiplier 406-2 and an impedance matching module 406-3. Generally, the modules 402-408 are associated with RF-EH, while the modules 410-416 are associated with communication. The RF-EH-capable UE 400 constitutes an example of a separated receiver architecture, as will be described in more detail below with respect to FIG. 5A. in particular, antenna 408 is dedicated to RF-EH circuitry 406, while antenna 410 is dedicated to communication circuitry (e.g., without antenna re-use, or switching or power-splitting RF-EH circuitry and communication circuitry).

FIG. 5A depicts an RF-EH architecture 500A (e.g., a separated receiver architecture) in accordance with an aspect of the disclosure. In FIG. 5A, the RF-EH architecture 500A includes a first set of antennas dedicated to RF-EH and coupled to RF-EH circuitry, and a second set of antennas dedicated to communication and coupled to communication circuitry. The RF-EH architecture 500A of FIG. 5A has a low complexity (e.g., no switching or power-splitting hardware, etc.), which may be advantageous for some applications. However, the RF-EH architecture 500A of FIG. 5A may be more expensive than other RF-EH architectures due to the inclusion of additional antennas dedicated to RF-EH. While the RF-EH architecture 500A depicts an example where the RF-EH circuitry includes a bank (or array) of antennas, in other designs, any number of antennas may be dedicated to the RF-EH circuitry. Likewise, while the RF-EH architecture 500A depicts an example where the communication circuitry includes a bank (or array) of antennas, in other designs, any number of antennas may be dedicated to the communication circuitry.

FIG. 5B depicts an RF-EH architecture 500B (e.g., a time-switching architecture) in accordance with another aspect of the disclosure. In FIG. 5B, the RF-EH architecture 500B includes a set of antennas that can, at different times, be alternately switched by a time switcher between RF-EH circuitry and communication circuitry. In this case, at any given time, the set of antennas can be used for RF-EH or communication, but not both at the same time. The RF-EH architecture 500B of FIG. 5B is more complex than the RF-EH architecture 500A of FIG. 5A due to the time-switching, but is more efficient in terms of antenna re-use. Generally, the RF-EH architecture 500B of FIG. 5B is suited for scenarios where the communication circuitry will not be used continuously, since the communication circuitry must be switched off to perform RF-EH. While the RF-EH architecture 500B depicts a single antenna being time-switched between the RF-EH circuitry and the communication circuitry, such a depiction is for convenience of explanation. In other designs, any number of antennas may be time-switched as described above.

FIG. 5C depicts an RF-EH architecture 500C (e.g., a power-splitting architecture) in accordance with another aspect of the disclosure. In FIG. 5C, the RF-EH architecture 500C includes a set of antennas coupled to a power splitter that splits RF power between RF-EH circuitry and communication circuitry. In this case, at any given time, the set of antennas can be used for both RF-EH and communication. The RF-EH architecture 500C of FIG. 5C is more complex than the RF-EH architecture 500A of FIG. 5A due to the power-splitting, but is more efficient in terms of antenna re-use. Also, unlike the RF-EH architecture 500B of FIG. 5B, the RF-EH architecture 500C of FIG. 5C may be particularly well suited for scenarios where the communication circuitry may at times be used continuously, since the communication circuitry need not be switched off to perform RF-EH. In some designs, the power splitter may allocate full RF power to either the RF-EH circuitry or the communication circuitry, which may approximate the operation of the time switcher from the RF-EH architecture 500B of FIG. 5B. While the RF-EH architecture 500B depicts a single antenna being power-split between the RF-EH circuitry and the communication circuitry, such a depiction is for convenience of explanation. In other designs, any number of antennas may be power-split as described above.

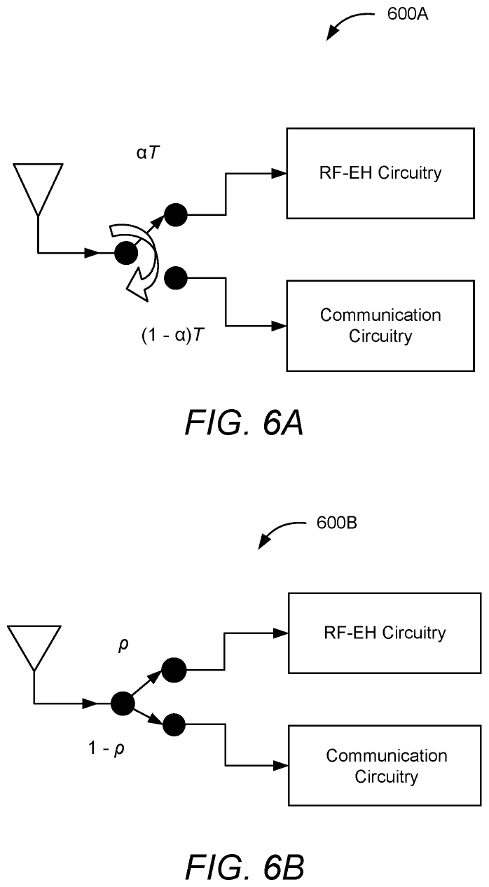

FIG. 6A illustrates a time-switching RF-EH architecture 600A in accordance with an aspect of the disclosure. The time-switching RF-EH architecture 600A depicts a more detailed example of the RF-EH architecture 500B of FIG. 5B. The time-switching RF-EH architecture 600A allows the RF-EH-capable UE to switch between communication circuitry or RF-EH circuitry. As noted above with to FIG. 5B, a time-switching RF-EH architecture permits the re-use of antennas for both RF-EH circuitry and communication circuitry, which may help to reduce the total number of antennas of a respective UE, which may in turn help drive down the associated cost. Moreover, a time-switching RF-EH architecture is suited for scenarios where the communication circuitry will not be used continuously, since the communication circuitry must be switched off to perform RF-EH. The energy harvested at receiver j from source i can be calculated as follows:

$${E}_{j} = η {P}_{i} {\vert {g}_{i - j} \vert}^{2} α T \qquad Equation 2$$

where 0≤α≤1 is the fraction of time allocated for energy harvesting. Letting K and W denote the noise spectral density and channel bandwidth, the data rate is given by:

$${R}_{i - j} = ( 1 - α ) {log}_{2} ( 1 + \frac{{\vert {g}_{i - j} \vert}^{2} {P}_{i}}{κ W} ) \qquad Equation 3$$

FIG. 6B illustrates a power-splitting RF-EH architecture 600B in accordance with an aspect of the disclosure. The power-switching RF-EH architecture 600B depicts a more detailed example of the RF-EH architecture 500C of FIG. 5C. As noted above with to FIG. 5C, a power-splitting RF-EH architecture permits the re-use of antennas for both RF-EH circuitry and communication circuitry, which may help to reduce the total number of antennas of a respective UE, which may in turn help drive down the associated cost. Moreover, a power-splitting RF-EH architecture is suited for scenarios where the communication circuitry may at times be used continuously, since the communication circuitry need not be switched off to perform RF-EH.

In the power-splitting RF-EH architecture 600B, the received RF signals are split into two streams for the communication circuitry and RF-EH circuitry with different power levels. The energy harvested at receiver j from source i can be calculated as:

$${E}_{j} = η ρ {P}_{i} {\vert {g}_{i - j} \vert}^{2} T \qquad Equation 4$$

where 0≤p≤1 is the fraction of power allocated for energy harvesting, with the data rate is given by:

$${R}_{i - j} = {log}_{2} ( 1 + \frac{{\vert {g}_{i - j} \vert}^{2} ( 1 - ρ ) {P}_{i}}{κ W} ) \qquad Equation 5$$

In some RF-EH implementations, sidelink transmissions (e.g., UE-to-UE transmissions) are used for RF-EH. Sidelink communications take place in transmission or reception resource pools. In some designs, the minimum resource allocation unit is a sub-channel in frequency, and resource allocation in time is one slot. Some slots are not available for sidelink. Some slots contain feedback resources. RRC configuration can be pre-configured (e.g., preloaded on UE) or network-configured (e.g., by gNB).

Various physical sidelink channels can be used for sidelink communication and/or RF-EH, including Physical sidelink control channel (PSCCH), Physical sidelink shared channel (PSSCH), Physical sidelink feedback channel (PSFCH), and Physical sidelink broadcast channel (PSBCH). Various sidelink reference signals can be used for sidelink communication and/or RF-EH, including Demodulation RS (DMRS) for PSCCH, Demodulation RS (DMRS) for PSSCH, Demodulation RS (DMRS) for PSBCH, Channel state information RS (CSI-RS), Primary synchronization signal (S-PSS), Secondary synchronization signal (S-SSS), and Phase-tracking RS (PTRS) for FR2 only.

In some designs, a slot may include 14 OFDM symbols including resource arranged in accordance with a time division duplex (TDD) resource configuration. In some designs, sidelink can be configured (e.g., pre-configured or dynamically configured) to occupy fewer than 14 symbols in a slot. In some designs, the first symbol is repeated on the preceding symbol for automatic gain control (AGC) settling. In some designs, the sub-channel size can be configured (e.g., pre-configured or dynamically configured) to {10, 15, 20, 25, 50, 75, 100} physical resource blocks (PRBs). In some designs, the PSCCH and PSSCH are always transmitted in the same slot.

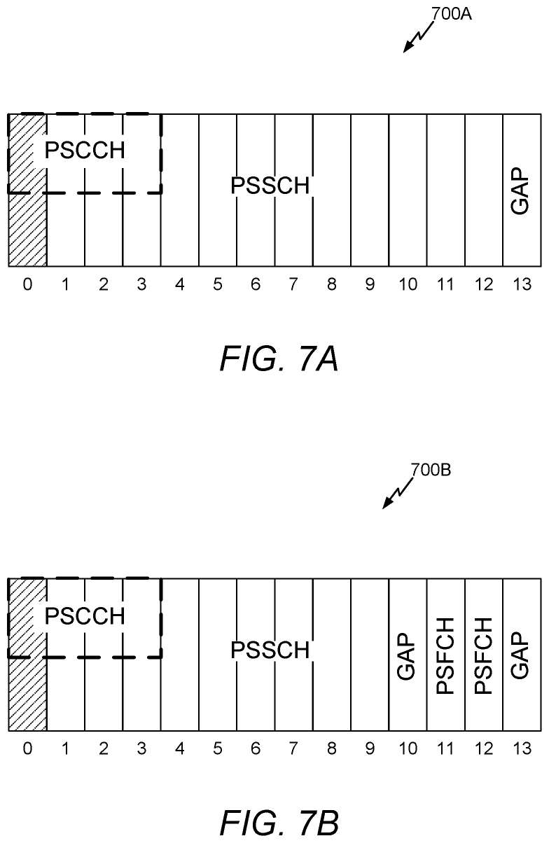

FIG. 7A illustrates a TDD resource configuration 700A in accordance with an aspect of the disclosure. In particular, the TDD resource configuration 700A is associated with sidelink communication. The TDD resource configuration 700A includes 14 OFDM symbols denoted as symbols 0 through 13. In the TDD resource configuration 700A of FIG. 7A, a gap symbol is configured at symbol 13 following PSSCH at symbol 12. The TDD resource configuration 700A merely depicts one example TDD resource configuration, and other TDD resource configurations are possible. Generally, the sidelink channels depicted in FIG. 7A are analogous in some ways to downlink and uplink channels. For example, the PSCCH is similar to the physical uplink control channel (PUCCH) or physical downlink control channel (PDSCH), and carries control information. Further, the PSSCH is similar to the physical uplink shared channel (PUSCH) or physical downlink shared channel (PDSCH), and carries data communication (e.g., as will be explained below in more detail, this data communication may comprise group-cast, broadcast and/or unicast data communication).

FIG. 7B illustrates a TDD resource configuration 700B in accordance with another aspect of the disclosure. In particular, the TDD resource configuration 700B is associated with sidelink communication. Unlike the TDD resource configuration 700A of FIG. 7A, the TDD resource configuration 700B includes OFDM symbols allocated to PSFCH. For example, PSCFH may be used to provide sidelink feedback, such as HARQ feedback (e.g., ACK/NACK). For example, some or all of the PSSCH may be associated with multicast or group-cast communications, and the PSFCH symbol(s) may provide one or more of the target UEs in a respective group to provide HARQ feedback related to the group-cast PSSCH communication(s).

In particular, the TDD resource configuration 700B includes 14 OFDM symbols denoted as symbols 0 through 13. In the TDD resource configuration 700B of FIG. 7B, a PSSCH at symbol 9 is followed by a first gap at symbol 10, which is followed by PSFCH at symbols 11-12, which is followed by a second gap at symbol 13. In FIG. 7B, the PSFCH is repeated at symbol 12 for AGC settling. In some designs, the PSFCH can be configured with a period of {0, 1, 2, 4} slots.

In some designs, sidelink control information is in two stages for forward compatibility. A first stage control (SCI-1) is transmitted on PSCCH and contains information for resource allocation and decoding second stage control. A second stage control (SCI-2) is transmitted on PSSCH and contains information for decoding data (SCH). SCI-1 will be decodable by UEs in all releases, whereas new SCI-2 formats can be introduced in future releases. This ensures that new features can be introduced while avoiding resource collisions between releases. Both SCI-1 and SCI-2 use the PDCCH polar code.

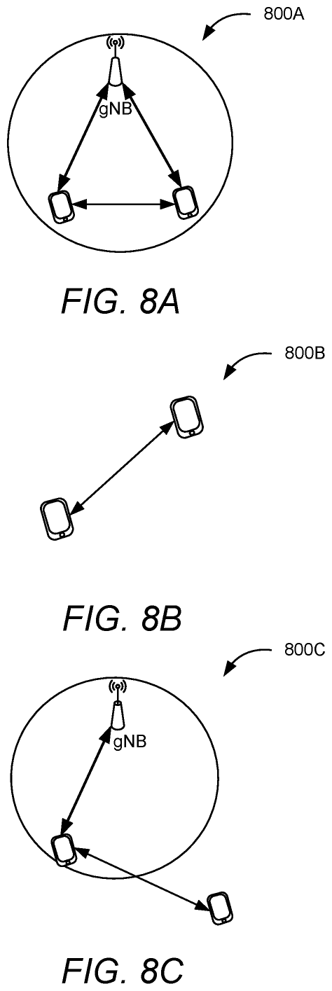

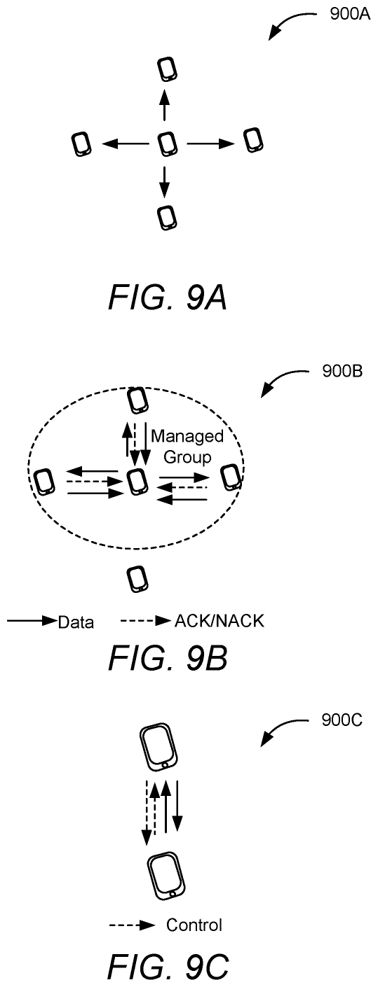

FIG. 8A illustrates an in-coverage (IC) scenario 800A in accordance with an aspect of the disclosure. In FIG. 8A, sidelink (SL) UEs are connected via UMTS air interface (or “Uu” interface) to a 5G core network (or “5GC”), SL authorization and provisioning via Uu necessary to support SL operation, and gNB may control the SL discovery/communication resource allocation. In some designs, RF-EH may be implemented on sidelink signaling exchanged between the respective UEs. However, if one or more of the UEs are relatively close to the gNB, RF-EH may be implemented on signaling exchanged between the UE(s) and the gNB. The signaling between the respective UEs and/or between the UE(s) and the gNB may be implemented via broadcast, group-cast or unicast, as will be described in more detail below with respect to FIGS. 9A-9C. In some designs, Uu communication may be implemented concurrently with SL communication. In some designs, Uu communication may include control information that is used to manage some or all of the SL communication between the UEs.

FIG. 8B illustrates an out-of-coverage (OOC) scenario 800B in accordance with an aspect of the disclosure. In FIG. 8B, SL are UEs not connected to 5GS, SL UEs must operate without authorization and provisioning via Uu, and SL UEs are pre-configured SL provisioning information for discovery/communication support. In some designs, RF-EH may be implemented on sidelink signaling exchanged between the respective UEs. The signaling between the respective UEs may be implemented via broadcast, group-cast or unicast, as will be described in more detail below with respect to FIGS. 9A-9C. Unlike FIG. 8A, Uu communication is not supported by the respective UEs in some designs (e.g., the respective UEs are Wi-Fi-only devices, or the UEs are cellular-capable but there is no gNB available or in-range, etc.).

FIG. 8C illustrates a partial coverage (PC) scenario 800C in accordance with an aspect of the disclosure. In FIG. 8C, one UE is connected via Uu to 5GC, another UE may or may not be connected to 5GS, one UE connects to 5GC using the UE in coverage (e.g., relay operation), and both UEs may support authorization/provisioning via Uu and pre-configured SL provisioning. In some designs, RF-EH may be implemented on sidelink signaling exchanged between the respective UEs. However, if the in-coverage UE is relatively close to the gNB, RF-EH may be implemented on signaling exchanged between the in-coverage UE and the gNB. The signaling between the respective UEs and/or between the in-coverage UE and the gNB may be implemented via broadcast, group-cast or unicast, as will be described in more detail below with respect to FIGS. 9A-9C. In some designs, Uu communication may be implemented concurrently with SL communication. In some designs, Uu communication may include control information that is used to manage some or all of the SL communication between the UEs.

FIG. 9A illustrates a sidelink communication scenario 900A in accordance with an aspect of the disclosure. In FIG. 9A, sidelink broadcast is implemented, whereby sidelink signals are transmitted one-to-many (e.g., sent to all users of a service) via blind transmission only, and with a predefined Destination ID per service. In some designs, sidelink broadcast may be implemented for RF-EH. For example, the broadcasting UE in FIG. 9A may be configured as a dedicated charging UE that provides power to proximate UEs in a particular area. Alternatively, the broadcasting UE in FIG. 9A may transmit data signals that are opportunistically energy harvested at one or more of the respective proximate UEs. In some designs, a subset of the target UEs may perform RF-EH on the sidelink broadcast signals (e.g., in addition to communication processing, or in lieu of communication processing in case of a time-switching RF-EH architecture), while another subset of the target UEs do not perform RF-EH (e.g., communication processing only). In either case, RF-EH is conventionally implemented in a receiver-centric manner without coordination with the RF-EH source.

FIG. 9B illustrates a sidelink communication scenario 900B in accordance with another aspect of the disclosure. In FIG. 9B, sidelink groupcast is implemented, whereby sidelink signals are transmitted one-to-many to a group of users identified by a group ID, with ACK/NACK-based retransmission, and with a destination ID learnt through application server or preconfigured. In some designs, sidelink group-cast may be implemented for RF-EH. In some designs, the group-casting UE in FIG. 9B may transmit data signals that are opportunistically energy harvested at one or more of the respective proximate UEs. In some designs, a subset of the target UEs may perform RF-EH on the sidelink group-cast signals (e.g., in addition to communication processing, or in lieu of communication processing in case of a time-switching RF-EH architecture), while another subset of the target UEs do not perform RF-EH (e.g., communication processing only). In either case, RF-EH is conventionally implemented in a receiver-centric manner without coordination with the RF-EH source. In some designs, feedback (e.g., ACK/NACK) may be sent back to the group-casting UE via a feedback channel, such as PSFCH as depicted in FIG. 7B.

FIG. 9C illustrates a sidelink communication scenario 900C in accordance with another aspect of the disclosure. In FIG. 9C, sidelink unicast is implemented, whereby sidelink signals are transmitted one-to-one (e.g., L2 link setup and maintenance), with ACK/NACK-based retransmission, and with a destination ID learnt through application server or preconfigured. In some designs, sidelink unicast may be implemented for RF-EH. In some designs, the transmitting UE in FIG. 9C may transmit data signals that are opportunistically energy harvested at the target UE. In some designs the target UE may perform RF-EH on the sidelink unicast signals (e.g., in addition to communication processing, or in lieu of communication processing in case of a time-switching RF-EH architecture). As noted above, RF-EH is conventionally implemented in a receiver-centric manner without coordination with the RF-EH source.

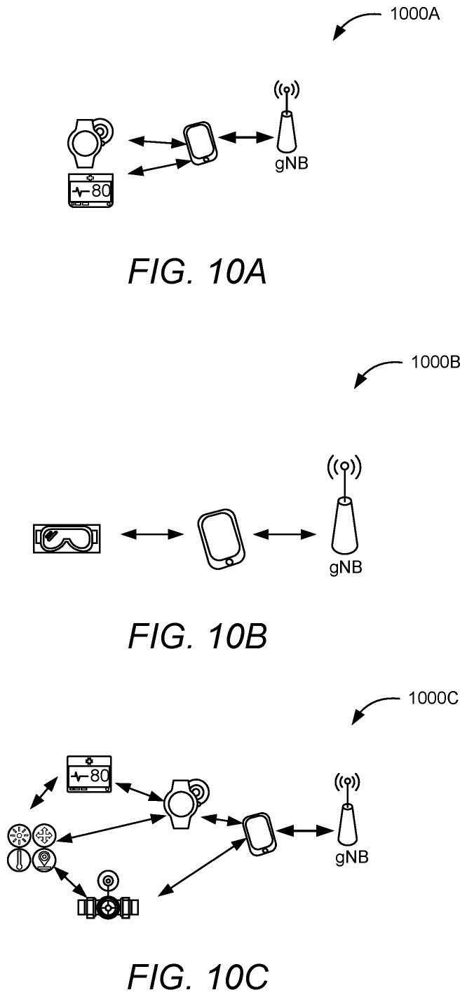

FIG. 10A illustrates a wearable use-case 1000A in accordance with an aspect of the disclosure. In FIG. 10A, smartwatch (e.g., with or without 5G modem) and a health monitoring device connected to the smartphone via SL. In FIG. 10A, the smartphone is shown as supporting UE-to-NW relay operation, although SL-only operation may be implemented. In some designs, wearable devices such as smartwatches, health monitoring devices, etc. may be good candidates for RF-EH due to their relatively low battery life and the inconvenience (or impracticality) of having the user remove the wearable devices for charging. Some health monitoring devices (e.g., pacemakers, etc.) may even be implemented into the user's body. In case of FIG. 10A, RF-EH circuitry may be equipped on the smartwatch and the health monitoring device, with SL communications from the smartphone being opportunistically harvested at the smartwatch and the health monitoring device. As noted above, the RF-EH circuitry may be implemented in accordance with a separated receiver architecture (e.g., as in FIG. 5A), a time-switching architecture (e.g., as in FIGS. 5B or 6A) or a power-splitting architecture (e.g., as in FIGS. 5C or 6B).

FIG. 10B illustrates a wearable use-case 1000B in accordance with another aspect of the disclosure. In FIG. 10B, an XR Head-Mounted Display (HMD) is connected to a smartphone via SL. In FIG. 10B, the smartphone is shown as supporting UE-to-NW relay operation, although SL-only operation may be implemented. In some designs, wearable devices such as HMDs may be good candidates for RF-EH due to their relatively low battery life and the inconvenience of having the user remove the HMD for charging. In case of FIG. 10B, RF-EH circuitry may be equipped on the HMD, with SL communications from the smartphone being opportunistically harvested at the HMD. As noted above, the RF-EH circuitry may be implemented in accordance with a separated receiver architecture (e.g., as in FIG. 5A), a time-switching architecture (e.g., as in FIGS. 5B or 6A) or a power-splitting architecture (e.g., as in FIGS. 5C or 6B).

FIG. 10C illustrates a wearable use-case 1000C in accordance with another aspect of the disclosure. In FIG. 10C, various sensors are communicating (directly or indirectly) with a smartphone via SL. In FIG. 10C, the smartphone is shown as supporting UE-to-NW relay operation, although SL-only operation may be implemented. As shown in FIG. 10C, some sensors may communicate amongst themselves (e.g., smart thermostat and entry key) or for mesh (e.g., UE-to-UE relay) over SL. In some designs, wearable devices such as smartwatches, health monitoring devices, sensors, etc. may be good candidates for RF-EH due to their relatively low battery life and the inconvenience (or impracticality) of having the user remove the wearable devices for charging. Some health monitoring devices (e.g., pacemakers, etc.) may even be implemented into the user's body. Moreover, some sensors may be installed behind walls or other obstructed locations, which makes wired-based charging mechanisms impractical. In case of FIG. 10C, RF-EH circuitry may be equipped on the sensors (e.g., smartwatch, the health monitoring device, thermostat, etc.), with SL communications from the smartphone being opportunistically harvested at the respective sensors. As noted above, the RF-EH circuitry may be implemented in accordance with a separated receiver architecture (e.g., as in FIG. 5A), a time-switching architecture (e.g., as in FIGS. 5B or 6A) or a power-splitting architecture (e.g., as in FIGS. 5C or 6B).

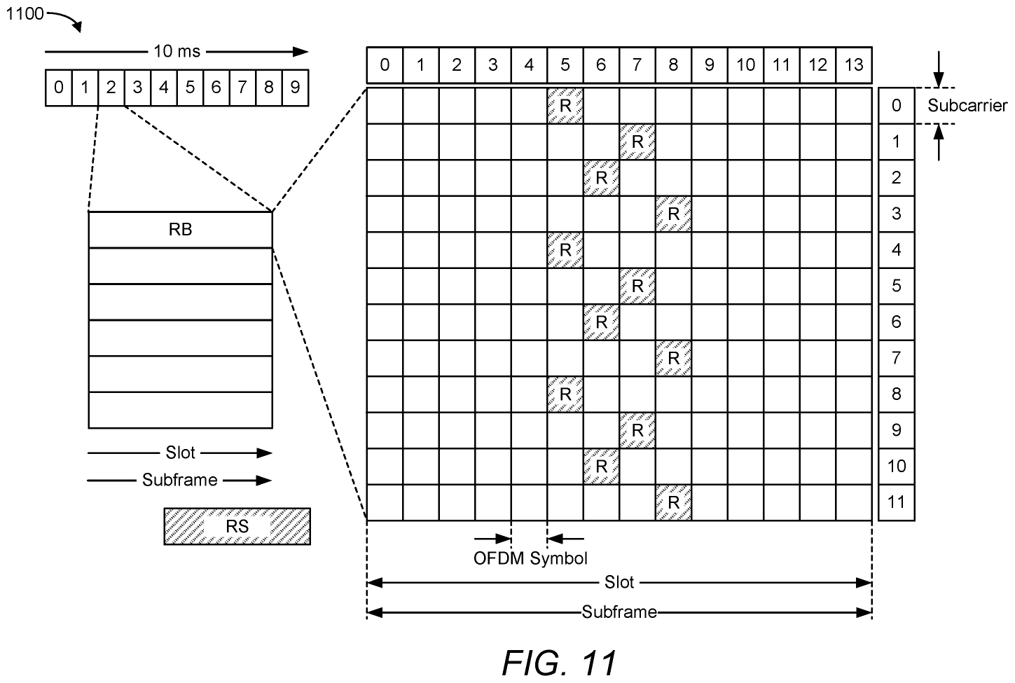

In addition to SL communications, RF-EH circuitry may also be used opportunistically to harvest Uu communications (i.e., uplink and/or downlink communications), such as those described below with respect to FIGS. 11-13.

Various frame structures may be used to support downlink and uplink transmissions between network nodes (e.g., base stations and UEs). FIG. 11 is a diagram 1100 illustrating an example frame structure, according to aspects of the disclosure. The frame structure may be a downlink or uplink frame structure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 11, a numerology of 15 kHz is used. Thus, in the time domain, a 10 ms frame is divided into 10 equally sized subframes of 1 ms each, and each subframe includes one time slot. In FIG. 11, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 11, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 11 illustrates example locations of REs carrying a reference signal (labeled “R”).

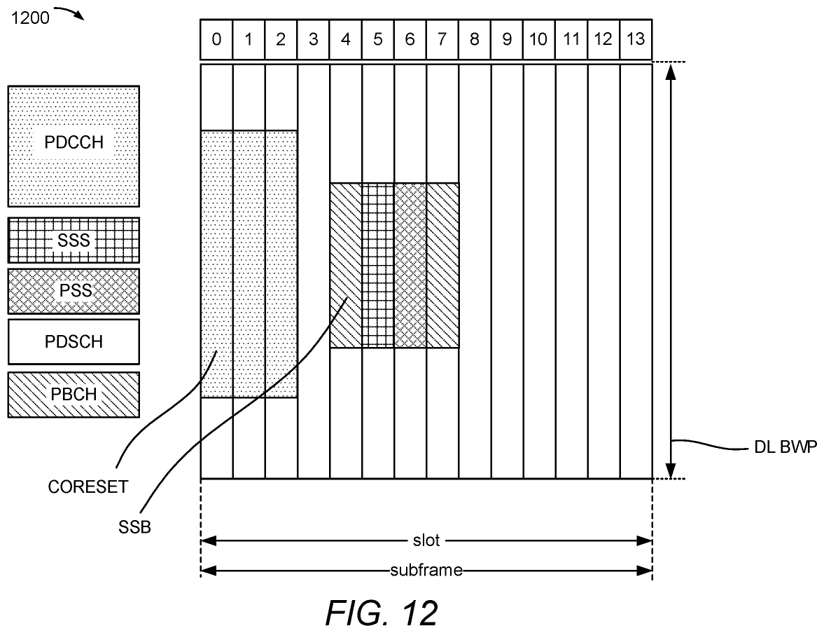

FIG. 12 is a diagram 1200 illustrating various downlink channels within an example downlink slot. In FIG. 12, time is represented horizontally (on the X axis) with time increasing from left to right, while frequency is represented vertically (on the Y axis) with frequency increasing (or decreasing) from bottom to top. In the example of FIG. 12, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 12, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 12, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 12 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

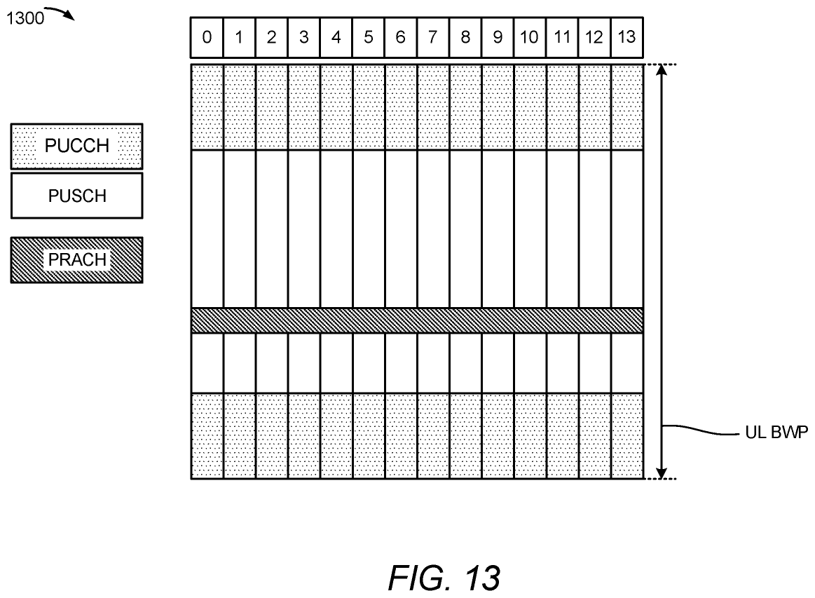

FIG. 13 is a diagram 1300 illustrating various uplink channels within an example uplink slot. In FIG. 13, time is represented horizontally (on the X axis) with time increasing from left to right, while frequency is represented vertically (on the Y axis) with frequency increasing (or decreasing) from bottom to top. In the example of FIG. 13, a numerology of 15 kHz is used. Thus, in the time domain, the illustrated slot is one millisecond (ms) in length, divided into 14 symbols.

A random-access channel (RACH), also referred to as a physical random-access channel (PRACH), may be within one or more slots within a frame based on the PRACH configuration. The PRACH may include six consecutive RB pairs within a slot. The PRACH allows the UE to perform initial system access and achieve uplink synchronization. A physical uplink control channel (PUCCH) may be located on edges of the uplink system bandwidth. The PUCCH carries uplink control information (UCI), such as scheduling requests, CSI reports, a channel quality indicator (CQI), a precoding matrix indicator (PMI), a rank indicator (RI), and HARQ ACK/NACK feedback. The physical uplink shared channel (PUSCH) carries data, and may additionally be used to carry a buffer status report (BSR), a power headroom report (PHR), and/or UCI.

RF-EH may be used to prolong the battery lifetime of various UEs (e.g., wearables, etc.). RF-EH may also provide incentives for devices to cooperative and relay other signals. RF-EH is typically implemented at the receiving device on energy associated with SL, DL and/or UL communications in an opportunistic manner, without actual coordination with the transmission (or energy) source.

Aspects of the disclosure are thereby directed to conveying, to a UE, an indication of a set of resources associated with a data communication from a first device to a second device (e.g., the first device and the second device being separate from the UE). In this case, the UE need not be an intended target of the data communication to harvest energy therefrom. The UE also need not perform ‘blind’ energy harvesting on resources without advance knowledge of associated data communications thereon. Such aspects may provide various technical advantages, such as facilitating more efficient power generation at UEs based on RF-EH (e.g., more efficient in the sense that the RF-EH is performed by UE on resources that are already being transmitted upon for a data communication between other devices,

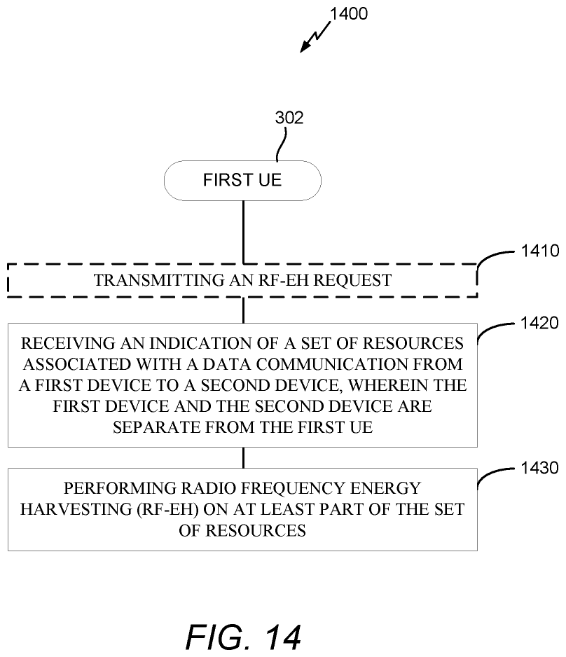

FIG. 14 illustrates an exemplary process 1400 of RF-EH, according to aspects of the disclosure. In an aspect, the process 1400 may be performed by a first UE (i.e., an RF-EH-capable UE), such as UE 302, UE 400, etc.

Referring to FIG. 14, at 1410, the first UE (e.g., transmitter 314 or 324, antenna 410, transceiver 412, etc.) optionally transmits an RF-EH request. In some designs, the transmission of the RF-EH request is optional because the first UE may alternatively receive an indication of resource(s) for RF-EH without solicitation. In some designs, the RF-EH request may be transmitted to an energy source (e.g., UE or gNB transmitting on the resource(s) for RF-EH). In other designs, the RF-EH request may be transmitted (e.g., via broadcast, etc.) to another entity (e.g., gNB or UE, etc.) which forwards the RF-EH request to an energy source.

Referring to FIG. 14, at 1420, the first UE (e.g., receiver 312 or 322, antenna 410, transceiver 412, etc.) receives an indication of a set of resources associated with a data communication from a first device to a second device, wherein the first device and the second device are separate from the first UE. In some designs, the indication at 1420 may be received in response to the optional RF-EH request from 1410 (e.g., the first UE transmits a request for energy, and the indication is provided to fulfill that request). In some designs, the set of resources comprises a set of downlink resources, or the set of resources comprises a set of uplink resources, or the set of resources comprises a set of sidelink resources. In some designs, the set of resources may include contiguous and/or non-contiguous time-frequency resources (e.g., RBs, etc.). In some designs, the reception at 1420 may be implemented via downlink (e.g., Uu) or sidelink.

Referring to FIG. 14, at 1430, the first UE (e.g., receiver 312 or 322, RF-EH circuitry 342 or 406, antenna 408, etc.) performs radio frequency energy harvesting (RF-EH) on at least part of the set of resources. In some designs, the RF-EH may correspond to dedicated RF-EH (e.g., all received RF power may be routed to RF-EH circuitry, e.g., via a time-switch or a dedicated power-split). In some designs, the first UE corresponds to a power-limited device (e.g., IoT sensor, solar-powered device, etc.) that may use the energy from RF-EH to charge a battery system thereon (e.g., to supplement some other energy source such as solar, etc.).

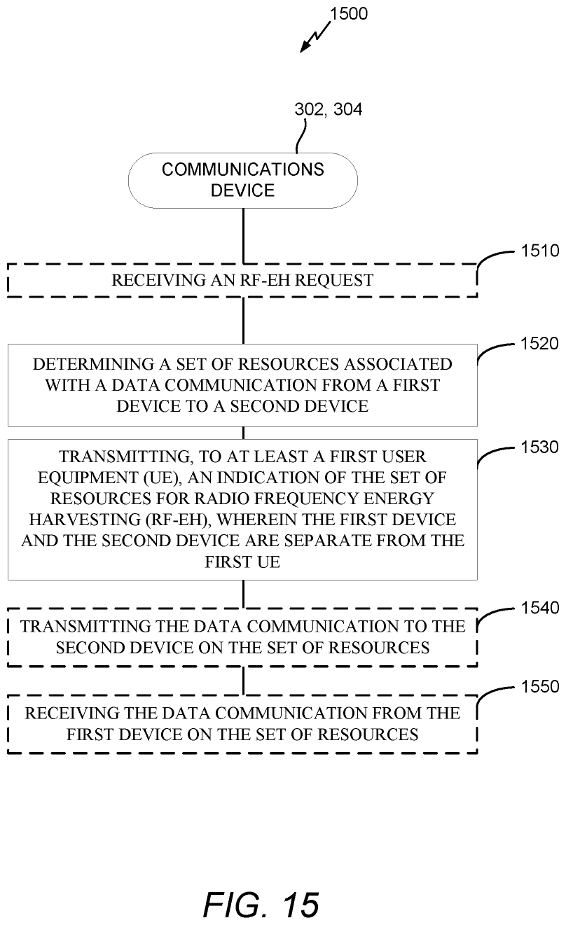

FIG. 15 illustrates an exemplary process 1500 of RF-EH, according to aspects of the disclosure. In an aspect, the process 1500 may be performed by a communications device (e.g., a UE such as UE 302 or 400, a gNB or BS such as BS 304, etc.).

Referring to FIG. 15, at 1510, the communications device (e.g., receiver 312 or 322 or 352 or 362, etc.) optionally receives an RF-EH request associated with a first UE. In some designs, the reception of the RF-EH request is optional because an indication of resource(s) for RF-EH may alternatively be transmitted without solicitation. In some designs, the communications device may correspond to an energy source (e.g., UE or gNB transmitting on the resource(s) for RF-EH). In other designs, the RF-EH request may be received (e.g., via broadcast, etc.) at the communications device (e.g., gNB or UE, etc.) which forwards the RF-EH request to an energy source.

Referring to FIG. 15, at 1520, the communications device (e.g., processor(s) 332 or 384, RF-EH circuitry 342 or 388, etc.) determines a set of resources associated with a data communication from a first device to a second device. In some designs, the set of resources comprises a set of downlink resources, or the set of resources comprises a set of uplink resources, or the set of resources comprises a set of sidelink resources. In some designs, the set of resources may include contiguous and/or non-contiguous time-frequency resources (e.g., RBs, etc.). In some designs, the set of resources may be configured at least in part based on the optional RF-EH request of 1510, as will be discussed below in more detail.

Referring to FIG. 15, at 1530, the communications device (e.g., transmitter 314 or 324 or 354 or 364, etc.) transmits, to at least a first user equipment (UE), an indication of the set of resources for radio frequency energy harvesting (RF-EH), wherein the first device and the second device are separate from the first UE. In some designs, the transmission at 1530 may be triggered in response to the optional RF-EH request from 1510 (e.g., the first UE transmits a request for energy, and the indication is provided to fulfill that request). In some designs, the transmission at 1530 may be implemented via downlink (e.g., Uu) or sidelink.

Referring to FIG. 15, at 1540, the communications device (e.g., transmitter 314 or 324 or 354 or 364, etc.) optionally transmits the data communication to the second device on the set of resources. For example, the optional transmission of 1540 may be performed in a scenario where the communications device corresponds to the first device. As noted above, the communications device may alternatively correspond to the second device or device that neither transmits nor receives the data communication (e.g., gNB for Mode 1 SL operation).

Referring to FIG. 15, at 1550, the communications device (e.g., transmitter 314 or 324 or 354 or 364, etc.) optionally receives the data communication from the first device on the set of resources. For example, the optional reception of 1550 may be performed in a scenario where the communications device corresponds to the second device. As noted above, the communications device may alternatively correspond to the first device or device that neither transmits nor receives the data communication (e.g., gNB for Mode 1 SL operation).

Referring to FIGS. 14-15, in some designs, the first device corresponds to a base station and the second device corresponds to a second UE, and the set of resources comprises a set of downlink resources (e.g., the communications device corresponds to the base station, or the communications device corresponds to the second UE). In other designs, the first device corresponds to a second UE and the second device corresponds to a base station, and the set of resources comprises a set of uplink resources (e.g., the communications device corresponds to the base station, or the communications device corresponds to the second UE). In other designs, the first device corresponds to a second UE and the second device corresponds to a third UE, and the set of resources comprises a set of sidelink resources (e.g., the communications device corresponds to the first UE, or the communications device corresponds to the second UE, or the communications device corresponds to a base station).

Referring to FIGS. 14-15, in some designs, the indication is sent from a second UE to the first UE (e.g., via sidelink). In other designs, the indication is sent from a base station to the first UE (e.g., via downlink or Uu).

Referring to FIGS. 14-15, in some designs, the communication of the indication is based on the data communication satisfying one or more RF-EH criteria (e.g., evaluated at the first UE to selectively trigger RF-EH request, or evaluated at the communications device to selectively trigger transmission of the indication). In some designs, the one or more RF-EH criteria include a transmission power level associated with the data communication, or a beam radiation pattern associated with the data communication, or a combination thereof. For example, a RF-EH-capable UE (e.g., IoT Ue) may transmit an EF-EH request to UEs that are close enough to provide energy for RF-EH from their respective UL transmissions or the DL signal sent to them or from SL transmission resources. A UE that receives such indication from other RF-EH-capable IoT devices or UEs would then share information about their UL transmissions or DL scheduling with these UEs if these transmissions satisfy certain conditions such as the UL transmission exceeds a certain power, or according to the beam radiation pattern, the RF-EH power at the RF-EH-capable UE is significant enough to harvest energy (e.g., above some threshold). In some designs, these conditions (or RF_EH criteria) may be implemented to ensure that the RF-EH-capable does not waste energy in an attempt to perform RF-EH.

Referring to FIGS. 14-15, in some designs, the indication is broadcast in a location region. In some designs, the location region is associated with a transmission beam from a base station (e.g., gNB will provide the indication on the transmission beam(s) where the data communication is to be transmitted on DL or a reciprocal beam for UL). In some designs, the location region is associated with a sidelink transmission range from a second UE (e.g., second UE broadcasts the indication via SL, and any in-range RF-EH-capable UE may then harvest energy from the data communication).

Referring to FIGS. 14-15, in some designs, the set of resources comprises a set of time resources (e.g., a time window, a set of slots, sub-slots, symbols, etc.), a set of frequency resources (e.g., a frequency range, etc.), or a combination thereof (e.g., time-frequency resources, such as RBs). For example, the UE(s) that receive an EF-EH request may respond with relevant information about DL scheduling and UL grants. In some designs, the UE(s) that receive an EF-EH request may respond with relevant information about SL grants (such as configured grants type 1 and 2, or resources determined/selected by a Tx-UE). This relevant information may include the time and frequency resources of the transmission, estimated received power and transmission beam, and so on. In some designs, the UE(s) that receive an EF-EH request may share this information with the network such that the network knows about the existence of UEs with need of RF-EH. The network (e.g., gNB, etc.) may then accommodate this knowledge in the scheduling such as the time and frequency resources and the transmission beam.

Referring to FIGS. 14-15, in some designs, the indication may correspond to an SL indication from a second UE related to Uu (UL/DL) resources or SL resources for SL Mode 1 or Mode 2 operation. For example, the second UE may indicate to other UEs through a sidelink channel the UL/DL grant resources in Uu and/or SL grant resources so that an RF-EH-capable UE (e.g., an IoT UE) can operate the RF-EH circuits (and adjust the RF-EH configuration) on those times of the indicated resources. In other designs, the indication may correspond to Uu indication by gNB on UU and SL Mode 1 resources. For example, gNB may indicate to UEs through Uu (DL) if UE is on coverage about the UL/DL grant resources in Uu (of other UEs) and/or SL grant resources under SL resource allocation (RA) Mode 1 (where gNB assign resources to Tx-UEs) so that an RF-EH-capable UE (e.g., IoT UE) can operate the RF-EH circuits on those times of those resources. In some designs, the gNB/UE may indicate to these UEs that are close enough to harvest energy from their respective UL transmissions or the DL signal sent to them.

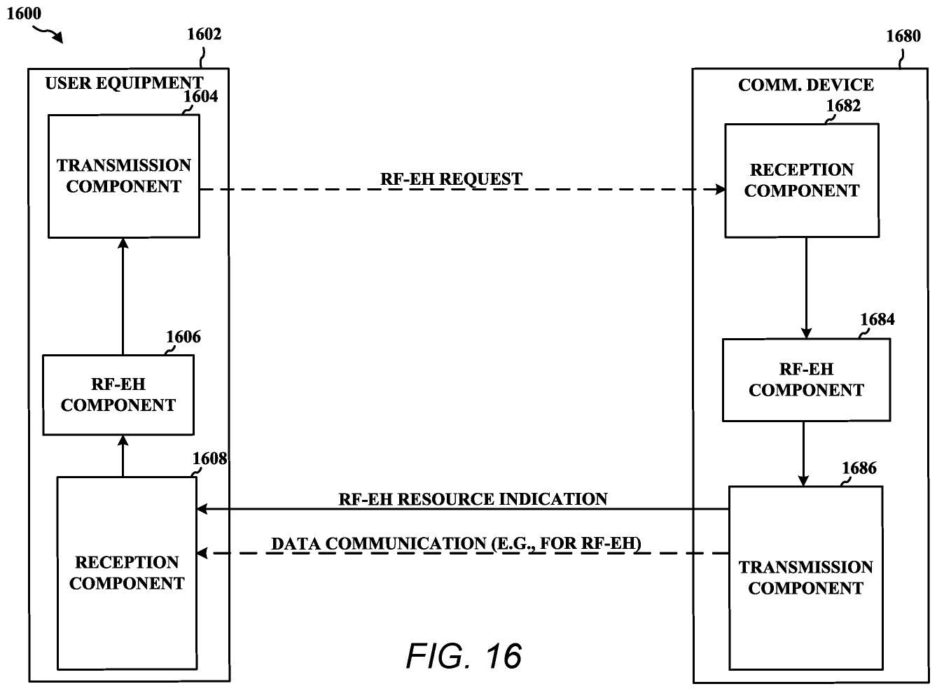

FIG. 16 is a conceptual data flow diagram 1600 illustrating the data flow between different means/components in exemplary apparatuses 1602 and 1680 in accordance with an aspect of the disclosure. The apparatus 1602 may be a UE (e.g., UE 302) in communication with an apparatus 1680, which may be a communications device (e.g., UE 302, BS 304).

The apparatus 1602 includes a transmission component 1604, which may correspond to transmitter circuitry in UE 302 as depicted in FIG. 3A, including transmitter(s) 314 and 324, antenna(s) 316 and 326, etc. The apparatus 1602 further includes RF-EH component 1606, which may correspond RF-EH circuitry 342 or 406, or an associated processing system such as processing system 332. The apparatus 1602 further includes a reception component 1608, which may correspond to receiver circuitry in UE 302 as depicted in FIG. 3A, including receiver(s) 312 and 322, antenna(s) 316 and 326, etc.

The apparatus 1680 includes a transmission component 1686, which may correspond to transmitter circuitry in UE 302 or BS 304 as depicted in FIG. 3A or FIG. 3B, including transmitter(s) 314 and 324 or 354 and 364, antenna(s) 316 and 326 or 356 and 366, etc. The apparatus 1680 further includes RF-EH component 1684, which may correspond to processor circuitry in UE 302 or BS 304 as depicted in FIG. 3A or FIG. 3B, including processing system 332 or 384, etc. The apparatus 1680 further includes a reception component 1682, which may correspond to receiver circuitry in UE 302 or BS 304 as depicted in FIG. 3A or FIG. 3B, including receiver(s) 312 and 322 or 352 and 362, antenna(s) 316 and 326 or 356 and 366, etc.

Referring to FIG. 16, the transmission component 1604 optionally transmits an RF-EH request to reception component 1682 of device 1680 (e.g., as noted above, this transmission is optional because the RF-EH resource indication may be provided without such solicitation, or the first UE may alternatively transmit the RF-EH request to an intermediary device). The RF-EH component 1684 may direct the transmission component 1686 to transmit an RF-EH resource indication to the reception component 1608. The transmission component 1686 optionally transmits the data communication for RF-EH to the reception component 1608 (e.g., as noted above, this transmission is optional because another device may transmit the data communication). The RF-EH 1606 facilitates RF-EH circuitry to harvest energy from the data communication (e.g., from the communication device or some other device).

One or more components of the apparatus 1602 and apparatus 1680 may perform each of the blocks of the algorithm in the aforementioned flowcharts of FIGS. 14-15. As such, each block in the aforementioned flowcharts of FIGS. 14-15 may be performed by a component and the apparatus 1602 and apparatus 1680 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

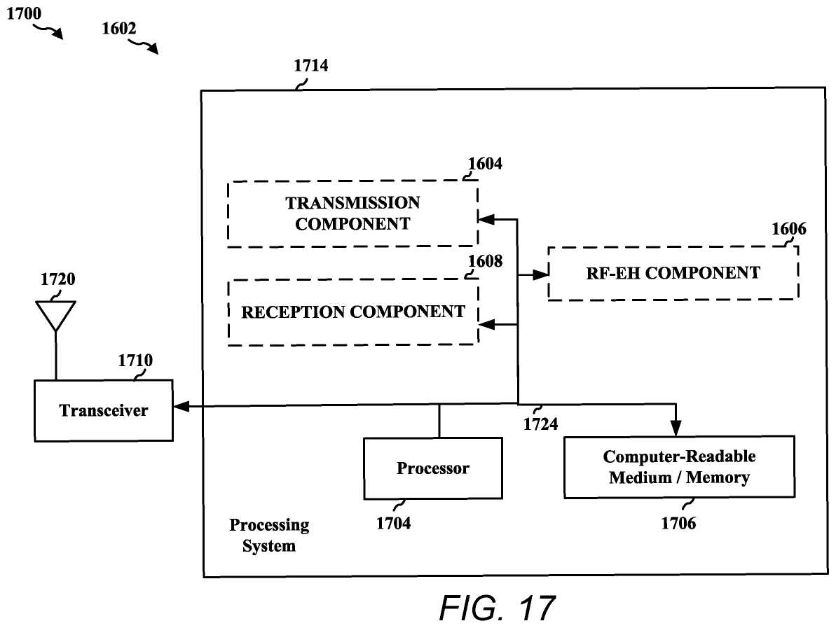

FIG. 17 is a diagram 1700 illustrating an example of a hardware implementation for an apparatus 1602 employing a processing system 1714. The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware components, represented by the processor 1704, the components 1604, 1606 and 1608, and the computer-readable medium/memory 1706. The bus 1724 may also link various other circuits such as timing sources, peripherals, voltage regulators, and power management circuits, which are well known in the art, and therefore, will not be described any further.

The processing system 1714 may be coupled to a transceiver 1710. The transceiver 1710 is coupled to one or more antennas 1720. The transceiver 1710 provides a means for communicating with various other apparatus over a transmission medium. The transceiver 1710 receives a signal from the one or more antennas 1720, extracts information from the received signal, and provides the extracted information to the processing system 1714, specifically the reception component 1608. In addition, the transceiver 1710 receives information from the processing system 1714, specifically the transmission component 1604, and based on the received information, generates a signal to be applied to the one or more antennas 1720. The processing system 1714 includes a processor 1704 coupled to a computer-readable medium/memory 1706. The processor 1704 is responsible for general processing, including the execution of software stored on the computer-readable medium/memory 1706. The software, when executed by the processor 1704, causes the processing system 1714 to perform the various functions described supra for any particular apparatus. The computer-readable medium/memory 1706 may also be used for storing data that is manipulated by the processor 1704 when executing software. The processing system 1714 further includes at least one of the components 1604, 1606 and 1608. The components may be software components running in the processor 1704, resident/stored in the computer readable medium/memory 1706, one or more hardware components coupled to the processor 1704, or some combination thereof.

In one configuration, the apparatus 1602 (e.g., a UE) for wireless communication includes means for receiving an indication of a set of resources associated with a data communication from a first device to a second device, wherein the first device and the second device are separate from the first UE, and means for performing radio frequency energy harvesting (RF-EH) on at least part of the set of resources.

The aforementioned means may be one or more of the aforementioned components of the apparatus 1602 and/or the processing system 1714 of the apparatus 1602 configured to perform the functions recited by the aforementioned means.

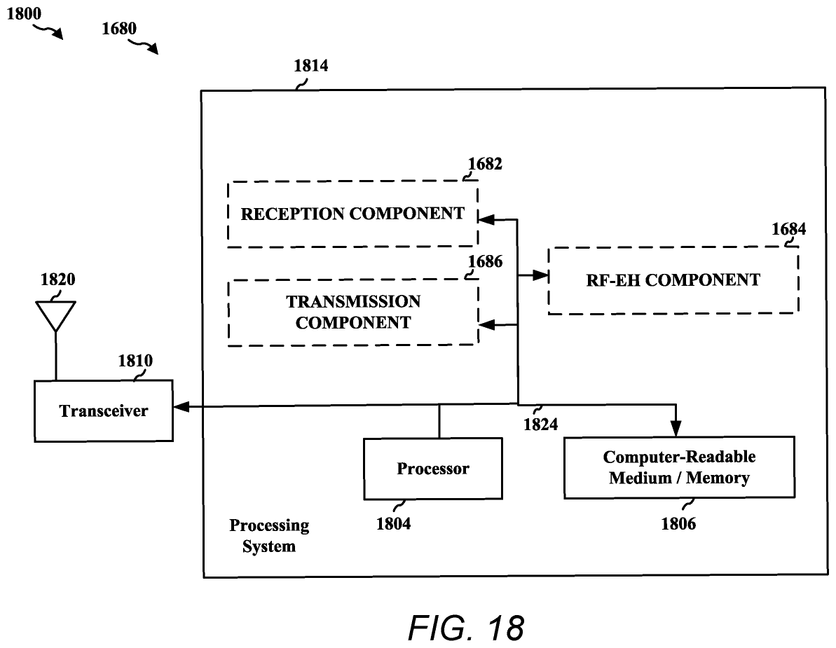

FIG. 18 is a diagram 1800 illustrating an example of a hardware implementation for an apparatus 1680 employing a processing system 1814. The processing system 1814 may be implemented with a bus architecture, represented generally by the bus 1824. The bus 1824 may include any number of interconnecting buses and bridges depending on the specific application of the processing system 1814 and the overall design constraints. The bus 1824 links together various circuits including one or more processors and/or hardware components, represented by the processor 1804, the components 1682, 1684 and 1686, and the computer-readable medium/memory 1806. The bus 1824 may also link various other circuits such as timing sources, peripherals, voltage regulators, and power management circuits, which are well known in the art, and therefore, will not be described any further.

The processing system 1814 may be coupled to a transceiver 1810. The transceiver 1810 is coupled to one or more antennas 1820. The transceiver 1810 provides a means for communicating with various other apparatus over a transmission medium. The transceiver 1810 receives a signal from the one or more antennas 1820, extracts information from the received signal, and provides the extracted information to the processing system 1814, specifically the reception component 1682. In addition, the transceiver 1810 receives information from the processing system 1814, specifically the transmission component 1686, and based on the received information, generates a signal to be applied to the one or more antennas 1820. The processing system 1814 includes a processor 1804 coupled to a computer-readable medium/memory 1806. The processor 1804 is responsible for general processing, including the execution of software stored on the computer-readable medium/memory 1806. The software, when executed by the processor 1804, causes the processing system 1814 to perform the various functions described supra for any particular apparatus. The computer-readable medium/memory 1806 may also be used for storing data that is manipulated by the processor 1804 when executing software. The processing system 1814 further includes at least one of the components 1682, 1684 and 1686. The components may be software components running in the processor 1804, resident/stored in the computer readable medium/memory 1806, one or more hardware components coupled to the processor 1804, or some combination thereof.

In one configuration, the apparatus 1680 (e.g., a BS or UE) for wireless communication may include means for determining a set of resources associated with a data communication from a first device to a second device, and means for transmitting, to at least a first user equipment (UE), an indication of the set of resources for radio frequency energy harvesting (RF-EH), wherein the first device and the second device are separate from the first UE.

The aforementioned means may be one or more of the aforementioned components of the apparatus 1680 and/or the processing system 1814 of the apparatus 1680 configured to perform the functions recited by the aforementioned means.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of operating a first user equipment (UE), comprising: receiving an indication of a set of resources associated with a data communication from a first device to a second device, wherein the first device and the second device are separate from the first UE; and performing radio frequency energy harvesting (RF-EH) on at least part of the set of resources.

Clause 2. The method of clause 1, wherein the first device corresponds to a base station and the second device corresponds to a second UE, and the set of resources comprises a set of downlink resources.

Clause 3. The method of any of clauses 1 to 2, wherein the first device corresponds to a second UE and the second device corresponds to a base station, and the set of resources comprises a set of uplink resources.

Clause 4. The method of any of clauses 1 to 3, wherein the first device corresponds to a second UE and the second device corresponds to a third UE, and the set of resources comprises a set of sidelink resources.

Clause 5. The method of any of clauses 1 to 4, wherein the indication is received from a second UE, or wherein the indication is received from a base station.

Clause 6. The method of any of clauses 1 to 5, wherein the reception of the indication is based on the data communication satisfying one or more RF-EH criteria.

Clause 7. The method of clause 6, wherein the one or more RF-EH criteria comprise: a transmission power level associated with the data communication, or a beam radiation pattern associated with the data communication, or a combination thereof.

Clause 8. The method of any of clauses 1 to 7, wherein the indication is broadcast in a location region.

Clause 9. The method of clause 8, wherein the location region is associated with a transmission beam from a base station, or wherein the location region is associated with a sidelink transmission range from a second UE.

Clause 10. The method of any of clauses 1 to 9, further comprising: transmitting an RF-EH request, wherein the indication is received in response to the RF-EH request.

Clause 11. The method of any of clauses 1 to 10, wherein the set of resources comprises a set of time resources, a set of frequency resources, or a combination thereof.

Clause 12. A method of operating a communications device, comprising: determining a set of resources associated with a data communication from a first device to a second device; and transmitting, to at least a first user equipment (UE), an indication of the set of resources for radio frequency energy harvesting (RF-EH), wherein the first device and the second device are separate from the first UE.

Clause 13. The method of clause 12, wherein the first device corresponds to a base station and the second device corresponds to a second UE, and the set of resources comprises a set of downlink resources.

Clause 14. The method of clause 13, wherein the communications device corresponds to the base station, or wherein the communications device corresponds to the second UE.

Clause 15. The method of any of clauses 12 to 14, wherein the first device corresponds to a second UE and the second device corresponds to a base station, and the set of resources comprises a set of uplink resources.

Clause 16. The method of clause 15, wherein the communications device corresponds to the base station, or wherein the communications device corresponds to the second UE.

Clause 17. The method of any of clauses 12 to 16, wherein the first device corresponds to a second UE and the second device corresponds to a third UE, and the set of resources comprises a set of sidelink resources.

Clause 18. The method of clause 17, wherein the communications device corresponds to the first UE, or wherein the communications device corresponds to the second UE, or wherein the communications device corresponds to a base station.

Clause 19. The method of any of clauses 12 to 18, wherein the transmission of the indication is responsive to a determination that the data communication satisfies one or more RF-EH criteria.

Clause 20. The method of any of clauses 12 to 19, wherein the transmission of the indication is based on the data communication satisfying one or more RF-EH criteria.

Clause 21. The method of clause 20, wherein the one or more RF-EH criteria comprise: a transmission power level associated with the data communication, or a beam radiation pattern associated with the data communication, or a combination thereof.

Clause 22. The method of any of clauses 12 to 21, wherein the indication is broadcast in a location region.

Clause 23. The method of clause 22, wherein the location region is associated with a transmission beam from a base station, or wherein the location region is associated with a sidelink transmission range from a second UE.

Clause 24. The method of any of clauses 12 to 23, further comprising: receiving an RF-EH request associated with the first UE, wherein the indication is transmitted in response to the RF-EH request.

Clause 25. The method of clause 24, wherein the data communication is scheduled on the set of resources based at least in part upon the RF-EH request.

Clause 26. The method of any of clauses 12 to 25, wherein the set of resources comprises a set of time resources, a set of frequency resources, or a combination thereof.

Clause 27. The method of any of clauses 12 to 26, wherein the communications device corresponds to the first device, further comprising: transmitting the data communication to the second device on the set of resources.

Clause 28. The method of any of clauses 12 to 27, wherein the communications device corresponds to the second device, further comprising: receiving the data communication from the first device on the set of resources.

Clause 29. A first user equipment (UE), comprising: a memory; at least one transceiver; and at least one processor communicatively coupled to the memory and the at least one transceiver, the at least one processor configured to: receive, via the at least one transceiver, an indication of a set of resources associated with a data communication from a first device to a second device, wherein the first device and the second device are separate from the first UE; and perform radio frequency energy harvesting (RF-EH) on at least part of the set of resources.

Clause 30. The first UE of clause 29, wherein the first device corresponds to a base station and the second device corresponds to a second UE, and the set of resources comprises a set of downlink resources.

Clause 31. The first UE of any of clauses 29 to 30, wherein the first device corresponds to a second UE and the second device corresponds to a base station, and the set of resources comprises a set of uplink resources.

Clause 32. The first UE of any of clauses 29 to 31, wherein the first device corresponds to a second UE and the second device corresponds to a third UE, and the set of resources comprises a set of sidelink resources.

Clause 33. The first UE of any of clauses 29 to 32, wherein the indication is received from a second UE, or wherein the indication is received from a base station.

Clause 34. The first UE of any of clauses 29 to 33, wherein the reception of the indication is based on the data communication satisfying one or more RF-EH criteria.

Clause 35. The first UE of clause 34, wherein the one or more RF-EH criteria comprise: a transmission power level associated with the data communication, or a beam radiation pattern associated with the data communication, or a combination thereof.

Clause 36. The first UE of any of clauses 29 to 35, wherein the indication is broadcast in a location region.

Clause 37. The first UE of clause 36, wherein the location region is associated with a transmission beam from a base station, or wherein the location region is associated with a sidelink transmission range from a second UE.

Clause 38. The first UE of any of clauses 29 to 37, wherein the at least one processor is further configured to: transmit, via the at least one transceiver, an RF-EH request, wherein the indication is received in response to the RF-EH request.

Clause 39. The first UE of any of clauses 29 to 38, wherein the set of resources comprises a set of time resources, a set of frequency resources, or a combination thereof.

Clause 40. A communications device, comprising: a memory; at least one transceiver; and at least one processor communicatively coupled to the memory and the at least one transceiver, the at least one processor configured to: determine a set of resources associated with a data communication from a first device to a second device; and transmit, via the at least one transceiver, to at least a first user equipment (UE), an indication of the set of resources for radio frequency energy harvesting (RF-EH), wherein the first device and the second device are separate from the first UE.

Clause 41. The communications device of clause 40, wherein the first device corresponds to a base station and the second device corresponds to a second UE, and the set of resources comprises a set of downlink resources.

Clause 42. The communications device of clause 41, wherein the communications device corresponds to the base station, or wherein the communications device corresponds to the second UE.

Clause 43. The communications device of any of clauses 40 to 42, wherein the first device corresponds to a second UE and the second device corresponds to a base station, and the set of resources comprises a set of uplink resources.

Clause 44. The communications device of clause 43, wherein the communications device corresponds to the base station, or wherein the communications device corresponds to the second UE.

Clause 45. The communications device of any of clauses 40 to 44, wherein the first device corresponds to a second UE and the second device corresponds to a third UE, and the set of resources comprises a set of sidelink resources.

Clause 46. The communications device of clause 45, wherein the communications device corresponds to the first UE, or wherein the communications device corresponds to the second UE, or wherein the communications device corresponds to a base station.

Clause 47. The communications device of any of clauses 40 to 46, wherein the transmission of the indication is responsive to a determination that the data communication satisfies one or more RF-EH criteria.

Clause 48. The communications device of any of clauses 40 to 47, wherein the transmission of the indication is based on the data communication satisfying one or more RF-EH criteria.

Clause 49. The communications device of clause 48, wherein the one or more RF-EH criteria comprise: a transmission power level associated with the data communication, or a beam radiation pattern associated with the data communication, or a combination thereof.

Clause 50. The communications device of any of clauses 40 to 49, wherein the indication is broadcast in a location region.

Clause 51. The communications device of clause 50, wherein the location region is associated with a transmission beam from a base station, or wherein the location region is associated with a sidelink transmission range from a second UE.

Clause 52. The communications device of any of clauses 40 to 51, wherein the at least one processor is further configured to: receive, via the at least one transceiver, an RF-EH request associated with the first UE, wherein the indication is transmitted in response to the RF-EH request.

Clause 53. The communications device of clause 52, wherein the data communication is scheduled on the set of resources based at least in part upon the RF-EH request.

Clause 54. The communications device of any of clauses 40 to 53, wherein the set of resources comprises a set of time resources, a set of frequency resources, or a combination thereof.

Clause 55. The communications device of any of clauses 40 to 54, wherein the communications device corresponds to the first device, further comprising: transmit, via the at least one transceiver, the data communication to the second device on the set of resources.

Clause 56. The communications device of any of clauses 40 to 55, wherein the communications device corresponds to the second device, further comprising: receive, via the at least one transceiver, the data communication from the first device on the set of resources.

Clause 57. A first user equipment (UE), comprising: means for receiving an indication of a set of resources associated with a data communication from a first device to a second device, wherein the first device and the second device are separate from the first UE; and means for performing radio frequency energy harvesting (RF-EH) on at least part of the set of resources.

Clause 58. The first UE of clause 57, wherein the first device corresponds to a base station and the second device corresponds to a second UE, and the set of resources comprises a set of downlink resources.

Clause 59. The first UE of any of clauses 57 to 58, wherein the first device corresponds to a second UE and the second device corresponds to a base station, and the set of resources comprises a set of uplink resources.

Clause 60. The first UE of any of clauses 57 to 59, wherein the first device corresponds to a second UE and the second device corresponds to a third UE, and the set of resources comprises a set of sidelink resources.

Clause 61. The first UE of any of clauses 57 to 60, wherein the indication is received from a second UE, or wherein the indication is received from a base station.

Clause 62. The first UE of any of clauses 57 to 61, wherein the reception of the indication is based on the data communication satisfying one or more RF-EH criteria.

Clause 63. The first UE of clause 62, wherein the one or more RF-EH criteria comprise: a transmission power level associated with the data communication, or a beam radiation pattern associated with the data communication, or a combination thereof.

Clause 64. The first UE of any of clauses 57 to 63, wherein the indication is broadcast in a location region.

Clause 65. The first UE of clause 64, wherein the location region is associated with a transmission beam from a base station, or wherein the location region is associated with a sidelink transmission range from a second UE.

Clause 66. The first UE of any of clauses 57 to 65, further comprising: means for transmitting an RF-EH request, wherein the indication is received in response to the RF-EH request.

Clause 67. The first UE of any of clauses 57 to 66, wherein the set of resources comprises a set of time resources, a set of frequency resources, or a combination thereof.

Clause 68. A communications device, comprising: means for determining a set of resources associated with a data communication from a first device to a second device; and means for transmitting, to at least a first user equipment (UE), an indication of the set of resources for radio frequency energy harvesting (RF-EH), wherein the first device and the second device are separate from the first UE.

Clause 69. The communications device of clause 68, wherein the first device corresponds to a base station and the second device corresponds to a second UE, and the set of resources comprises a set of downlink resources.

Clause 70. The communications device of clause 69, wherein the communications device corresponds to the base station, or wherein the communications device corresponds to the second UE.

Clause 71. The communications device of any of clauses 68 to 70, wherein the first device corresponds to a second UE and the second device corresponds to a base station, and the set of resources comprises a set of uplink resources.

Clause 72. The communications device of clause 71, wherein the communications device corresponds to the base station, or wherein the communications device corresponds to the second UE.

Clause 73. The communications device of any of clauses 68 to 72, wherein the first device corresponds to a second UE and the second device corresponds to a third UE, and the set of resources comprises a set of sidelink resources.

Clause 74. The communications device of clause 73, wherein the communications device corresponds to the first UE, or wherein the communications device corresponds to the second UE, or wherein the communications device corresponds to a base station.

Clause 75. The communications device of any of clauses 68 to 74, wherein the transmission of the indication is responsive to a determination that the data communication satisfies one or more RF-EH criteria.

Clause 76. The communications device of any of clauses 68 to 75, wherein the transmission of the indication is based on the data communication satisfying one or more RF-EH criteria.

Clause 77. The communications device of clause 76, wherein the one or more RF-EH criteria comprise: a transmission power level associated with the data communication, or a beam radiation pattern associated with the data communication, or a combination thereof.

Clause 78. The communications device of any of clauses 68 to 77, wherein the indication is broadcast in a location region.

Clause 79. The communications device of clause 78, wherein the location region is associated with a transmission beam from a base station, or wherein the location region is associated with a sidelink transmission range from a second UE.

Clause 80. The communications device of any of clauses 68 to 79, further comprising: means for receiving an RF-EH request associated with the first UE, wherein the indication is transmitted in response to the RF-EH request.

Clause 81. The communications device of clause 80, wherein the data communication is scheduled on the set of resources based at least in part upon the RF-EH request.

Clause 82. The communications device of any of clauses 68 to 81, wherein the set of resources comprises a set of time resources, a set of frequency resources, or a combination thereof.

Clause 83. The communications device of any of clauses 68 to 82, wherein the communications device corresponds to the first device, further comprising: means for transmitting the data communication to the second device on the set of resources.

Clause 84. The communications device of any of clauses 68 to 83, wherein the communications device corresponds to the second device, further comprising: means for receiving the data communication from the first device on the set of resources.

Clause 85. A non-transitory computer-readable medium storing computer-executable instructions that, when executed by a first user equipment (UE), cause the first UE to: receive an indication of a set of resources associated with a data communication from a first device to a second device, wherein the first device and the second device are separate from the first UE; and perform radio frequency energy harvesting (RF-EH) on at least part of the set of resources.

Clause 86. The non-transitory computer-readable medium of clause 85, wherein the first device corresponds to a base station and the second device corresponds to a second UE, and the set of resources comprises a set of downlink resources.

Clause 87. The non-transitory computer-readable medium of any of clauses 85 to 86, wherein the first device corresponds to a second UE and the second device corresponds to a base station, and the set of resources comprises a set of uplink resources.

Clause 88. The non-transitory computer-readable medium of any of clauses 85 to 87, wherein the first device corresponds to a second UE and the second device corresponds to a third UE, and the set of resources comprises a set of sidelink resources.

Clause 89. The non-transitory computer-readable medium of any of clauses 85 to 88, wherein the indication is received from a second UE, or wherein the indication is received from a base station.

Clause 90. The non-transitory computer-readable medium of any of clauses 85 to 89, wherein the reception of the indication is based on the data communication satisfying one or more RF-EH criteria.

Clause 91. The non-transitory computer-readable medium of clause 90, wherein the one or more RF-EH criteria comprise: a transmission power level associated with the data communication, or a beam radiation pattern associated with the data communication, or a combination thereof.

Clause 92. The non-transitory computer-readable medium of any of clauses 85 to 91, wherein the indication is broadcast in a location region.

Clause 93. The non-transitory computer-readable medium of clause 92, wherein the location region is associated with a transmission beam from a base station, or wherein the location region is associated with a sidelink transmission range from a second UE.

Clause 94. The non-transitory computer-readable medium of any of clauses 85 to 93, further comprising computer-executable instructions that, when executed by the first UE, cause the first UE to: transmit an RF-EH request, wherein the indication is received in response to the RF-EH request.

Clause 95. The non-transitory computer-readable medium of any of clauses 85 to 94, wherein the set of resources comprises a set of time resources, a set of frequency resources, or a combination thereof.

Clause 96. A non-transitory computer-readable medium storing computer-executable instructions that, when executed by a communications device, cause the communications device to: determine a set of resources associated with a data communication from a first device to a second device; and transmit, to at least a first user equipment (UE), an indication of the set of resources for radio frequency energy harvesting (RF-EH), wherein the first device and the second device are separate from the first UE.

Clause 97. The non-transitory computer-readable medium of clause 96, wherein the first device corresponds to a base station and the second device corresponds to a second UE, and the set of resources comprises a set of downlink resources.

Clause 98. The non-transitory computer-readable medium of clause 97, wherein the communications device corresponds to the base station, or wherein the communications device corresponds to the second UE.

Clause 99. The non-transitory computer-readable medium of any of clauses 96 to 98, wherein the first device corresponds to a second UE and the second device corresponds to a base station, and the set of resources comprises a set of uplink resources.

Clause 100. The non-transitory computer-readable medium of clause 99, wherein the communications device corresponds to the base station, or wherein the communications device corresponds to the second UE.

Clause 101. The non-transitory computer-readable medium of any of clauses 96 to 100, wherein the first device corresponds to a second UE and the second device corresponds to a third UE, and the set of resources comprises a set of sidelink resources.

Clause 102. The non-transitory computer-readable medium of clause 101, wherein the communications device corresponds to the first UE, or wherein the communications device corresponds to the second UE, or wherein the communications device corresponds to a base station.

Clause 103. The non-transitory computer-readable medium of any of clauses 96 to 102, wherein the transmission of the indication is responsive to a determination that the data communication satisfies one or more RF-EH criteria.

Clause 104. The non-transitory computer-readable medium of any of clauses 96 to 103, wherein the transmission of the indication is based on the data communication satisfying one or more RF-EH criteria.

Clause 105. The non-transitory computer-readable medium of clause 104, wherein the one or more RF-EH criteria comprise: a transmission power level associated with the data communication, or a beam radiation pattern associated with the data communication, or a combination thereof.

Clause 106. The non-transitory computer-readable medium of any of clauses 96 to 105, wherein the indication is broadcast in a location region.

Clause 107. The non-transitory computer-readable medium of clause 106, wherein the location region is associated with a transmission beam from a base station, or wherein the location region is associated with a sidelink transmission range from a second UE.

Clause 108. The non-transitory computer-readable medium of any of clauses 96 to 107, further comprising computer-executable instructions that, when executed by the communications device, cause the communications device to: receive an RF-EH request associated with the first UE, wherein the indication is transmitted in response to the RF-EH request.

Clause 109. The non-transitory computer-readable medium of clause 108, wherein the data communication is scheduled on the set of resources based at least in part upon the RF-EH request.

Clause 110. The non-transitory computer-readable medium of any of clauses 96 to 109, wherein the set of resources comprises a set of time resources, a set of frequency resources, or a combination thereof.

Clause 111. The non-transitory computer-readable medium of any of clauses 96 to 110, wherein the communications device corresponds to the first device, further comprising: transmit the data communication to the second device on the set of resources.

Clause 112. The non-transitory computer-readable medium of any of clauses 96 to 111, wherein the communications device corresponds to the second device, further comprising: receive the data communication from the first device on the set of resources.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A first user equipment (UE), comprising:
a memory;
at least one transceiver; and
at least one processor communicatively coupled to the memory and the at least one transceiver, the at least one processor configured to:
receive, via the at least one transceiver, an indication of a set of resources associated with a data communication from a first device to a second device, wherein the first device and the second device are separate from the first UE; and
perform radio frequency energy harvesting (RF-EH) on at least part of the set of resources.

2. The first UE of claim 1, wherein the first device corresponds to a base station and the second device corresponds to a second UE, and the set of resources comprises a set of downlink resources.

3. The first UE of claim 1, wherein the first device corresponds to a second UE and the second device corresponds to a base station, and the set of resources comprises a set of uplink resources.

4. The first UE of claim 1, wherein the first device corresponds to a second UE and the second device corresponds to a third UE, and the set of resources comprises a set of sidelink resources.

5. The first UE of claim 1,
wherein the indication is received from a second UE, or
wherein the indication is received from a base station.

6. The first UE of claim 1, wherein the reception of the indication is based on the data communication satisfying one or more RF-EH criteria.

7. The first UE of claim 6, wherein the one or more RF-EH criteria comprise:
a transmission power level associated with the data communication, or
a beam radiation pattern associated with the data communication, or
a combination thereof.

8. The first UE of claim 1, wherein the indication is broadcast in a location region.

9. The first UE of claim 8,
wherein the location region is associated with a transmission beam from a base station, or
wherein the location region is associated with a sidelink transmission range from a second UE.

10. The first UE of claim 1, wherein the at least one processor is further configured to:
transmit, via the at least one transceiver, an RF-EH request,
wherein the indication is received in response to the RF-EH request.

11. The first UE of claim 1, wherein the set of resources comprises a set of time resources, a set of frequency resources, or a combination thereof.

12. A communications device, comprising:
a memory;
at least one transceiver; and
at least one processor communicatively coupled to the memory and the at least one transceiver, the at least one processor configured to:
determine a set of resources associated with a data communication from a first device to a second device; and
transmit, via the at least one transceiver, to at least a first user equipment (UE), an indication of the set of resources for radio frequency energy harvesting (RF-EH), wherein the first device and the second device are separate from the first UE.

13. The communications device of claim 12, wherein the first device corresponds to a base station and the second device corresponds to a second UE, and the set of resources comprises a set of downlink resources.

14. The communications device of claim 13,
wherein the communications device corresponds to the base station, or
wherein the communications device corresponds to the second UE.

15. The communications device of claim 12, wherein the first device corresponds to a second UE and the second device corresponds to a base station, and the set of resources comprises a set of uplink resources.

16. The communications device of claim 15,
wherein the communications device corresponds to the base station, or
wherein the communications device corresponds to the second UE.

17. The communications device of claim 12, wherein the first device corresponds to a second UE and the second device corresponds to a third UE, and the set of resources comprises a set of sidelink resources.

18. The communications device of claim 17,
wherein the communications device corresponds to the first UE, or
wherein the communications device corresponds to the second UE, or
wherein the communications device corresponds to a base station.

19. The communications device of claim 12, wherein the transmission of the indication is responsive to a determination that the data communication satisfies one or more RF-EH criteria.

20. The communications device of claim 19, wherein the one or more RF-EH. criteria comprise:
a transmission power level associated with the data communication, or
a beam radiation pattern associated with the data communication, or
a combination thereof.

21. The communications device of claim 12, wherein the indication is broadcast in a location region.

22. The communications device of claim 21, wherein the location region is associated with a transmission beam from a base station.

23. The communications device of claim 21, wherein the location region is associated with a sidelink transmission range from a second UE.

24. The communications device of claim 12, wherein the at least one processor is further configured to:
receive, via the at least one transceiver, an RF-EH request associated with the first UE,
wherein the indication is transmitted in response to the RF-EH request.

25. The communications device of claim 24, wherein the data communication is scheduled on the set of resources based at least in part upon the RF-EH request.

26. The communications device of claim 12, wherein the set of resources comprises a set of time resources, a set of frequency resources, or a combination thereof.

27. The communications device of claim 12,
wherein the communications device corresponds to the first device, further comprising:
transmit, via the at least one transceiver, the data communication to the second device on the set of resources.

28. The communications device of claim 12,
wherein the communications device corresponds to the second device, further comprising:
receive, via the at least one transceiver, the data communication from the first device on the set of resources.

29. A method of operating a first user equipment (UE), comprising:
receiving an indication of a set of resources associated with a data communication from a first device to a second device, wherein the first device and the second device are separate from the first UE; and
performing radio frequency energy harvesting (RF-EH) on at least part of the set of resources.

30. A method of operating a communications device, comprising:
determining a set of resources associated with a data communication from a first device to a second device; and
transmitting, to at least a first user equipment (UE), an indication of the set of resources for radio frequency energy harvesting (RF-EH), wherein the first device and the second device are separate from the first UE.
